(19) United States
(12) Patent Application Publication
(10) Pub. No.: US 2026/0089626 A1
(43) Pub. Date: Mar. 26, 2026

(54) SIDELINK SYNCHRONIZATION SIGNALING

(71) Applicant: QUALCOMM Incorporated, San Diego, CA (US)

(72) Inventors: Sourjya DUTTA, San Diego, CA (US); Navid ABEDINI, Basking Ridge, NJ (US); Kapil GULATI, Belle Mead, NJ (US)

(21) Appl. No.: 18/895,865

(22) Filed: Sep. 25, 2024

(51) Int. Cl. H04W 52/02; H04W 76/14; H04W 76/27

(52) U.S. Cl. CPC H04W 52/0216; H04W 52/0235; H04W 76/14; H04W 76/27

(57) ABSTRACT

Various aspects of the present disclosure generally relate to wireless communication. In some aspects, a remote user equipment (UE) may establish a sidelink with a relay UE. The UE may transmit a discontinuous reception (DRX) indication that indicates that the remote UE is entering a sidelink DRX cycle that includes one or more active states and one or more sleep states, the one or more active states synchronized with one or more wake-up signal periods. The UE may receive a sidelink synchronization signal based at least in part on prioritizing synchronization signals from the relay UE. The UE may monitor for a wake-up signal in the one or more wake-up signal periods. Numerous other aspects are described.

### FIELD OF THE DISCLOSURE

Aspects of the present disclosure generally relate to wireless communication and specifically relate to techniques, apparatuses, and methods for sidelink synchronization signaling.

### BACKGROUND

Wireless communication systems are widely deployed to provide various services that may include carrying voice, text, messaging, video, data, and/or other traffic. The services may include unicast, multicast, and/or broadcast services, among other examples. Typical wireless communication systems may employ multiple-access radio access technologies (RATs) capable of supporting communication with multiple users by sharing available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

The above multiple-access RATs have been adopted in various telecommunication standards to provide common protocols that enable different wireless communication devices to communicate on a municipal, national, regional, or global level. An example telecommunication standard is New Radio (NR). NR, which may also be referred to as 5G, is part of a continuous mobile broadband evolution promulgated by the Third Generation Partnership Project (3GPP). NR (and other mobile broadband evolutions beyond NR) may be designed to better support Internet of things (IoT) and reduced capability device deployments, industrial connectivity, millimeter wave (mmWave) expansion, licensed and unlicensed spectrum access, non-terrestrial network (NTN) deployment, sidelink and other device-to-device direct communication technologies (for example, cellular vehicle-to-everything (CV2X) communication), massive multiple-input multiple-output (MIMO), disaggregated network architectures and network topology expansions, multiple-subscriber implementations, high-precision positioning, and/or radio frequency (RF) sensing, among other examples. As the demand for mobile broadband access continues to increase, further improvements in NR may be implemented, and other radio access technologies such as 6G may be introduced, to further advance mobile broadband evolution.

### SUMMARY

Some aspects described herein relate to a method of wireless communication performed by a remote user equipment (UE). The method may include establishing a sidelink with a relay UE. The method may include transmitting a discontinuous reception (DRX) indication that indicates that the remote UE is entering a sidelink DRX cycle that includes one or more active states and one or more sleep states, the one or more active states synchronized with one or more wake-up signal periods. The method may include receiving a sidelink synchronization signal based at least in part on prioritizing synchronization signals from the relay UE. The method may include monitoring, based at least in part on receiving the sidelink synchronization signal, for a wake-up signal in the one or more wake-up signal periods.

Some aspects described herein relate to a method of wireless communication performed by a relay UE. The method may include establishing a sidelink with a remote UE. The method may include receiving a DRX indication that indicates that the remote UE is entering a sidelink DRX cycle that includes one or more active states and one or more sleep states, the one or more active states synchronized with one or more wake-up signal periods. The method may include operating, based at least in part on receiving the DRX indication, as a relay synchronization source for the remote UE. The method may include transmitting, based at least in part on operating as the relay synchronization source, a sidelink synchronization signal that is directed to the remote UE.

Some aspects described herein relate to an apparatus for wireless communication at a remote UE. The apparatus may include one or more memories and one or more processors coupled to the one or more memories. The one or more processors may be configured to establish a sidelink with a relay UE. The one or more processors may be configured to transmit a DRX indication that indicates that the remote UE is entering a sidelink DRX cycle that includes one or more active states and one or more sleep states, the one or more active states synchronized with one or more wake-up signal periods. The one or more processors may be configured to receive a sidelink synchronization signal based at least in part on prioritizing synchronization signals from the relay UE. The one or more processors may be configured to monitor, based at least in part on receiving the sidelink synchronization signal, for a wake-up signal in the one or more wake-up signal periods.

Some aspects described herein relate to an apparatus for wireless communication at a relay UE. The apparatus may include one or more memories and one or more processors coupled to the one or more memories. The one or more processors may be configured to establish a sidelink with a remote UE. The one or more processors may be configured to receive a DRX indication that indicates that the remote UE is entering a sidelink DRX cycle that includes one or more active states and one or more sleep states, the one or more active states synchronized with one or more wake-up signal periods. The one or more processors may be configured to operate, based at least in part on receiving the DRX indication, as a relay synchronization source for the remote UE. The one or more processors may be configured to transmit, based at least in part on operating as the relay synchronization source, a sidelink synchronization signal that is directed to the remote UE.

Some aspects described herein relate to a non-transitory computer-readable medium that stores a set of instructions for wireless communication by a remote UE. The set of instructions, when executed by one or more processors of the UE, may cause the UE to establish a sidelink with a relay UE. The set of instructions, when executed by one or more processors of the UE, may cause the UE to transmit a DRX indication that indicates that the remote UE is entering a sidelink DRX cycle that includes one or more active states and one or more sleep states, the one or more active states synchronized with one or more wake-up signal periods. The set of instructions, when executed by one or more processors of the UE, may cause the UE to receive a sidelink synchronization signal based at least in part on prioritizing synchronization signals from the relay UE. The set of instructions, when executed by one or more processors of the UE, may cause the UE to monitor, based at least in part on receiving the sidelink synchronization signal, for a wake-up signal in the one or more wake-up signal periods.

Some aspects described herein relate to a non-transitory computer-readable medium that stores a set of instructions for wireless communication by a relay UE. The set of instructions, when executed by one or more processors of the UE, may cause the UE to establish a sidelink with a remote UE. The set of instructions, when executed by one or more processors of the UE, may cause the UE to receive a DRX indication that indicates that the remote UE is entering a sidelink DRX cycle that includes one or more active states and one or more sleep states, the one or more active states synchronized with one or more wake-up signal periods. The set of instructions, when executed by one or more processors of the UE, may cause the UE to operate, based at least in part on receiving the DRX indication, as a relay synchronization source for the remote UE. The set of instructions, when executed by one or more processors of the UE, may cause the UE to transmit, based at least in part on operating as the relay synchronization source, a sidelink synchronization signal that is directed to the remote UE.

Some aspects described herein relate to an apparatus for wireless communication. The apparatus may include means for establishing a sidelink with a relay UE. The apparatus may include means for transmitting a DRX indication that indicates that the remote UE is entering a sidelink DRX cycle that includes one or more active states and one or more sleep states, the one or more active states synchronized with one or more wake-up signal periods. The apparatus may include means for receiving a sidelink synchronization signal based at least in part on prioritizing synchronization signals from the relay UE. The apparatus may include means for monitoring, based at least in part on receiving the sidelink synchronization signal, for a wake-up signal in the one or more wake-up signal periods.

Some aspects described herein relate to an apparatus for wireless communication. The apparatus may include means for establishing a sidelink with a remote UE. The apparatus may include means for receiving a DRX indication that indicates that the remote UE is entering a sidelink DRX cycle that includes one or more active states and one or more sleep states, the one or more active states synchronized with one or more wake-up signal periods. The apparatus may include means for operating, based at least in part on receiving the DRX indication, as a relay synchronization source for the remote UE. The apparatus may include means for transmitting, based at least in part on operating as the relay synchronization source, a sidelink synchronization signal that is directed to the remote UE.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, the specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure, but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network, in accordance with the present disclosure.

FIG. 2 is a diagram illustrating an example network node in communication with an example user equipment (UE) in a wireless network, in accordance with the present disclosure.

FIG. 3 is a diagram illustrating an example disaggregated base station architecture, in accordance with the present disclosure.

FIG. 4 is a diagram illustrating an example of sidelink communications, in accordance with the present disclosure.

FIG. 5 is a diagram illustrating an example of sidelink communications and access link communications, in accordance with the present disclosure.

FIG. 6 is a diagram illustrating an example of a discontinuous reception configuration, in accordance with the present disclosure.

FIG. 7 is a diagram illustrating an example of a relay UE that relays communications between a remote UE and a network node, in accordance with the present disclosure.

FIG. 8 is a diagram illustrating an example of sidelink synchronization, in accordance with the present disclosure.

FIGS. 9A and 9B, collectively, illustrate a diagram of an example wireless communication process between a network node, a relay UE, and a remote UE, in accordance with the present disclosure.

FIG. 10 is a diagram illustrating an example process performed, for example, at a UE or an apparatus of a UE, in accordance with the present disclosure.

FIG. 11 is a diagram illustrating an example process performed, for example, at a UE or an apparatus of a UE, in accordance with the present disclosure.

FIG. 12 is a diagram of an example apparatus for wireless communication, in accordance with the present disclosure.

### DETAILED DESCRIPTION

Various aspects of the present disclosure are described hereinafter with reference to the accompanying drawings. However, aspects of the present disclosure may be embodied in many different forms and is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

A wireless network may use a relay user equipment (UE) to extend coverage that is provided to a remote UE, such as in scenarios that include the remote UE operating at an out-of-coverage (OOC) location that is outside of a service coverage area that is provided by a network node. For example, the remote UE may connect to the network node indirectly through the relay UE via a sidelink and/or a PC-5 connection, and the relay UE may relay communications between the remote UE and the network node. The relaying of communications may include paging communications from the network node that are directed to the remote UE.

“Sidelink synchronization” may denote a process in which UEs that are connected to one another (e.g., via a sidelink) establish and maintain timing and/or frequency alignment to enable reliable communications between the UEs. As one example, the relay UE may maintain synchronization with the network node based at least in part on one or more synchronization signals transmitted by the network node via the access link with the relay UE, and the remote UE 710 may maintain synchronization with the relay UE using one or more synchronization signals transmitted by the relay UE using a sidelink with the remote UE. The remote UE may alternatively, or additionally, be connected to other OOC UEs via respective sidelinks, and the relay UE and the remote UE may maintain sidelink synchronization using synchronization signals from one of the OOC UEs.

At times, a UE (e.g., the remote UE and/or the relay UE) may determine that a loss of sidelink synchronization has occurred based at least in part on detecting a failure in a connection maintenance procedure (e.g., failure in a keep-alive procedure).

Accordingly, the UE may change from using a first sidelink synchronization source (e.g., a first UE, a network node, and/or a Global Navigation Satellite System (GNSS) source) to a second sidelink synchronization source (e.g., a second UE, another network node, and/or another GNSS source). Switching between sidelink synchronization sources may be governed by rules, such as rules specified by a communication standard and/or rules configured by a network node. In some scenarios, these selection rules for a sidelink synchronization signal may pose some challenges for an OOC remote UE.

As one example, the remote UE may operate in a discontinuous reception (DRX) cycle to save power, such as a sidelink DRX cycle. As at least part of operating in the sidelink DRX cycle, the remote UE may monitor for sidelink synchronization signals as part of transitioning to and/or operating in an active duration of the sidelink DRX cycle, such as by monitoring sidelink synchronization signal resources. In some cases, a sidelink configuration used by the UE may prioritize a GNSS-based sidelink synchronization source higher than a network-node-based sidelink synchronization source. Based at least in part on UE-mobility, the remote UE may fail to detect and/or lose the higher priority sidelink synchronization source that is used as a common sidelink synchronization source between the remote UE and the relay UE. Based at least in part on losing the higher priority sidelink synchronization source, the remote UE may synchronize to another UE, resulting in a mismatch of sidelink synchronization sources between a relay UE and a remote UE. Another example of losing a common synchronization source may include the remote UE experiencing an antenna blockage, such as a blockage that is due to a moving object or a hand placement on the remote UE. When the remote UE is not operating with an enabled DRX cycle, the mismatch of sidelink synchronization sources may be quickly identified by the remote UE and/or the relay UE using link-level measurement metrics. However, when the remote UE is operating with an enabled a DRX cycle, the remote UE may operate in an inactive state for multiple durations and/or long durations that result in sidelink synchronization loss and/or a mismatch in synchronization sources. A loss and/or mismatch in sidelink synchronization between a remote UE and a relay UE may result in a dropped sidelink connection, an increase in data recovery errors in the sidelink, a decrease in data throughput in the sidelink, and/or an increase in data transfer latency in the sidelink.

Various aspects relate generally to sidelink synchronization signaling. Some aspects more specifically relate to a remote UE that is operating in a sidelink DRX cycle prioritizing a synchronization signal from a relay UE that is connected to the remote UE via a sidelink. In some aspects, a remote UE may establish a sidelink with a relay UE. The remote UE may transmit (e.g., via a sidelink) a DRX indication that indicates that the remote UE is entering a sidelink DRX cycle, and the sidelink DRX cycle may include one or more active states and one or more sleep states, where the one or more active states may be synchronized with one or more wake-up signal periods. The remote UE may receive a wake-up signal in one of the one or more wake-up signal periods. Based at least in part on receiving the wake-up signal, the remote UE may monitor for a sidelink synchronization signal based at least in part on prioritizing synchronization signals from the relay UE.

In some aspects, a relay UE may establish a sidelink with a remote UE. The relay UE may receive a DRX indication that indicates that the remote UE is entering a sidelink DRX cycle that includes one or more active states and one or more sleep states, where the one or more active states may be synchronized with one or more wake-up signal periods. Based at least in part on receiving the DRX indication, the relay UE may operate as a relay synchronization source for the remote UE. Operating as a relay synchronization source may include the relay UE transmitting a wake-up signal in one of the wake-up signal periods and transmitting a sidelink synchronization signal that is directed to the remote UE.

Particular aspects of the subject matter described in this disclosure can be implemented to realize one or more of the following potential advantages. In some examples, by prioritizing a synchronization signal from a relay UE, the described techniques can be used to enable a remote UE to mitigate a mismatch in sidelink synchronization with the relay UE. Mitigating a mismatch in sidelink synchronization between a remote UE and a relay UE may mitigate a dropped sidelink connection, may decrease data recovery errors in the sidelink, may increase data throughput in the sidelink, and/or may decrease data transfer latency in the sidelink.

Multiple-access radio access technologies (RATs) have been adopted in various telecommunication standards to provide common protocols that enable wireless communication devices to communicate on a municipal, enterprise, national, regional, or global level. For example, 5G New Radio (NR) is part of a continuous mobile broadband evolution promulgated by the Third Generation Partnership Project (3GPP). 5G NR supports various technologies and use cases including enhanced mobile broadband (eMBB), ultra-reliable low-latency communication (URLLC), massive machine-type communication (mMTC), millimeter wave (mmWave) technology, beamforming, network slicing, edge computing, Internet of Things (IoT) connectivity and management, and network function virtualization (NFV).

As the demand for broadband access increases and as technologies supported by wireless communication networks evolve, further technological improvements may be adopted in or implemented for 5G NR or future RATs, such as 6G, to further advance the evolution of wireless communication for a wide variety of existing and new use cases and applications. Such technological improvements may be associated with new frequency band expansion, licensed and unlicensed spectrum access, overlapping spectrum use, small cell deployments, non-terrestrial network (NTN) deployments, disaggregated network architectures and network topology expansion, device aggregation, advanced duplex communication, sidelink and other device-to-device direct communication, IoT (including passive or ambient IoT) networks, reduced capability (RedCap) UE functionality, industrial connectivity, multiple-subscriber implementations, high-precision positioning, radio frequency (RF) sensing, and/or artificial intelligence or machine learning (AI/ML), among other examples. These technological improvements may support use cases such as wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples. The methods, operations, apparatuses, and techniques described herein may enable one or more of the foregoing technologies and/or support one or more of the foregoing use cases.

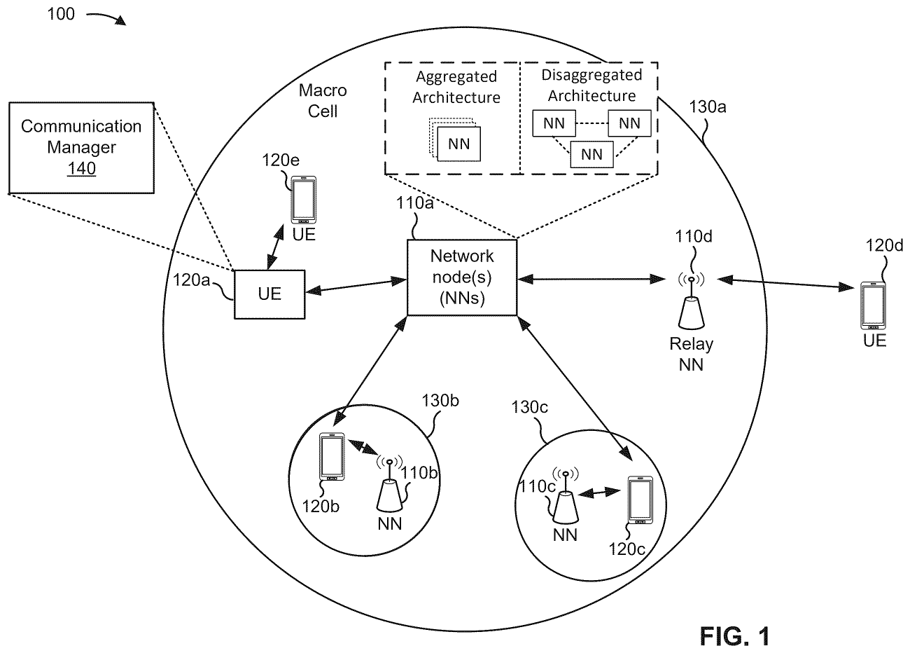

FIG. 1 is a diagram illustrating an example of a wireless communication network 100, in accordance with the present disclosure. The wireless communication network 100 may be or may include elements of a 5G (or NR) network or a 6G network, among other examples. The wireless communication network 100 may include multiple network nodes 110, shown as a network node (NN) 110a, a network node 110b, a network node 110c, and a network node 110d. The network nodes 110 may support communications with multiple UEs 120, shown as a UE 120a, a UE 120b, a UE 120c, a UE 120d, and a UE 120e.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency ranges. Examples of RATs include a 4G RAT, a 5G/NR RAT, and/or a 6G RAT, among other examples. In some examples, when multiple RATs are deployed in a given geographic area, each RAT in the geographic area may operate on different frequencies to avoid interference with one another.

Various operating bands have been defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “Sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into mid-band frequencies. Thus, “sub-6 GHz,” if used herein, may broadly refer to frequencies that are less than 6 GHz, that are within FR1, and/or that are included in mid-band frequencies. Similarly, the term “millimeter wave,” if used herein, may broadly refer to frequencies that are included in mid-band frequencies, that are within FR2, FR4, FR4-a or FR4-1, or FR5, and/or that are within the EHF band. Higher frequency bands may extend 5G NR operation, 6G operation, and/or other RATs beyond 52.6 GHz. For example, each of FR4a, FR4-1, FR4, and FR5 falls within the EHF band. In some examples, the wireless communication network 100 may implement dynamic spectrum sharing (DSS), in which multiple RATs (for example, 4G/Long Term Evolution (LTE) and 5G/NR) are implemented with dynamic bandwidth allocation (for example, based on user demand) in a single frequency band. It is contemplated that the frequencies included in these operating bands (for example, FR1, FR2, FR3, FR4, FR4-a, FR4-1, and/or FR5) may be modified, and techniques described herein may be applicable to those modified frequency ranges.

A network node 110 may include one or more devices, components, or systems that enable communication between a UE 120 and one or more devices, components, or systems of the wireless communication network 100. A network node 110 may be, may include, or may also be referred to as an NR network node, a 5G network node, a 6G network node, a Node B, an eNB, a gNB, an access point (AP), a transmission reception point (TRP), a mobility element, a core, a network entity, a network element, a network equipment, and/or another type of device, component, or system included in a radio access network (RAN).

A network node 110 may be implemented as a single physical node (for example, a single physical structure) or may be implemented as two or more physical nodes (for example, two or more distinct physical structures). For example, a network node 110 may be a device or system that implements part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node (having an aggregated architecture), meaning that the network node 110 may implement a full radio protocol stack that is physically and logically integrated within a single node (for example, a single physical structure) in the wireless communication network 100. For example, an aggregated network node 110 may consist of a single standalone base station or a single TRP that uses a full radio protocol stack to enable or facilitate communication between a UE 120 and a core network of the wireless communication network 100.

Alternatively, and as also shown, a network node 110 may be a disaggregated network node (sometimes referred to as a disaggregated base station), meaning that the network node 110 may implement a radio protocol stack that is physically distributed and/or logically distributed among two or more nodes in the same geographic location or in different geographic locations. For example, a disaggregated network node may have a disaggregated architecture. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating base station functionality into multiple units that can be individually deployed.

The network nodes 110 of the wireless communication network 100 may include one or more central units (CUs), one or more distributed units (DUs), and/or one or more radio units (RUs). A CU may host one or more higher layer control functions, such as radio resource control (RRC) functions, packet data convergence protocol (PDCP) functions, and/or service data adaptation protocol (SDAP) functions, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host one or more lower PHY layer functions, such as a fast Fourier transform (FFT), an inverse FFT (iFFT), beamforming, physical random access channel (PRACH) extraction and filtering, and/or scheduling of resources for one or more UEs 120, among other examples. An RU may host RF processing functions or lower PHY layer functions, such as an FFT, an iFFT, beamforming, or PRACH extraction and filtering, among other examples, according to a functional split, such as a lower layer functional split. In such an architecture, each RU can be operated to handle over the air (OTA) communication with one or more UEs 120.

In some aspects, a single network node 110 may include a combination of one or more CUs, one or more DUs, and/or one or more RUs. Additionally or alternatively, a network node 110 may include one or more Near-Real Time (Near-RT) RAN Intelligent Controllers (RICs) and/or one or more Non-Real Time (Non-RT) RICs. In some examples, a CU, a DU, and/or an RU may be implemented as a virtual unit, such as a virtual central unit (VCU), a virtual distributed unit (VDU), or a virtual radio unit (VRU), among other examples. A virtual unit may be implemented as a virtual network function, such as associated with a cloud deployment.

Some network nodes 110 (for example, a base station, an RU, or a TRP) may provide communication coverage for a particular geographic area. In the 3GPP, the term “cell” can refer to a service coverage area of a network node 110 or to a network node 110 itself, depending on the context in which the term is used. A network node 110 may support one or multiple (for example, three) cells. In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In some examples, a cell may not necessarily be stationary. For example, the geographic area of the cell may move according to the location of an associated mobile network node 110 (for example, a train, a satellite base station, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. In the example shown in FIG. 1, the network node 110a may be a macro network node for a macro cell 130a, the network node 110b may be a pico network node for a pico cell 130b, and the network node 110c may be a femto network node for a femto cell 130c. Various different types of network nodes 110 may generally transmit at different power levels, serve different service coverage areas, and/or have different impacts on interference in the wireless communication network 100 than other types of network nodes 110. For example, macro network nodes may have a high transmit power level (for example, 5 to 40 watts), whereas pico network nodes, femto network nodes, and relay network nodes may have lower transmit power levels (for example, 0.1 to 2 watts).

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink channels may include one or more control channels and one or more data channels. A downlink control channel may be used to transmit downlink control information (DCI) (for example, scheduling information, reference signals, and/or configuration information) from a network node 110 to a UE 120. A downlink data channel may be used to transmit downlink data (for example, user data associated with a UE 120) from a network node 110 to a UE 120. Downlink control channels may include one or more physical downlink control channels (PDCCHs), and downlink data channels may include one or more physical downlink shared channels (PDSCHs). Uplink channels may similarly include one or more control channels and one or more data channels. An uplink control channel may be used to transmit uplink control information (UCI) (for example, reference signals and/or feedback corresponding to one or more downlink transmissions) from a UE 120 to a network node 110. An uplink data channel may be used to transmit uplink data (for example, user data associated with a UE 120) from a UE 120 to a network node 110. Uplink control channels may include one or more physical uplink control channels (PUCCHs), and uplink data channels may include one or more physical uplink shared channels (PUSCHs). The downlink and the uplink may each include a set of resources on which the network node 110 and the UE 120 may communicate.

Downlink and uplink resources may include time domain resources (frames, subframes, slots, and/or symbols), frequency domain resources (frequency bands, component carriers, subcarriers, resource blocks, and/or resource elements), and/or spatial domain resources (particular transmit directions and/or beam parameters). Frequency domain resources of some bands may be subdivided into bandwidth parts (BWPs). A BWP may be a continuous block of frequency domain resources (for example, a continuous block of resource blocks) that are allocated for one or more UEs 120. A UE 120 may be configured with both an uplink BWP and a downlink BWP (where the uplink BWP and the downlink BWP may be the same BWP or different BWPs). A BWP may be dynamically configured (for example, by a network node 110 transmitting a DCI configuration to the one or more UEs 120) and/or reconfigured, which means that a BWP can be adjusted in real-time (or near-real-time) based on changing network conditions in the wireless communication network 100 and/or based on the specific requirements of the one or more UEs 120. This enables more efficient use of the available frequency domain resources in the wireless communication network 100 because fewer frequency domain resources may be allocated to a BWP for a UE 120 (which may reduce the quantity of frequency domain resources that a UE 120 is required to monitor), leaving more frequency domain resources to be spread across multiple UEs 120. Thus, BWPs may also assist in the implementation of lower-capability UEs 120 by facilitating the configuration of smaller bandwidths for communication by such UEs 120.

As described above, in some aspects, the wireless communication network 100 may be, may include, or may be included in, an IAB network. In an IAB network, at least one network node 110 is an anchor network node that communicates with a core network. An anchor network node 110 may also be referred to as an IAB donor (or “IAB-donor”). The anchor network node 110 may connect to the core network via a wired backhaul link. For example, an Ng interface of the anchor network node 110 may terminate at the core network. Additionally or alternatively, an anchor network node 110 may connect to one or more devices of the core network that provide a core access and mobility management function (AMF). An IAB network also generally includes multiple non-anchor network nodes 110, which may also be referred to as relay network nodes or simply as IAB nodes (or “IAB-nodes”). Each non-anchor network node 110 may communicate directly with the anchor network node 110 via a wireless backhaul link to access the core network, or may communicate indirectly with the anchor network node 110 via one or more other non-anchor network nodes 110 and associated wireless backhaul links that form a backhaul path to the core network. Some anchor network node 110 or other non-anchor network node 110 may also communicate directly with one or more UEs 120 via wireless access links that carry access traffic. In some examples, network resources for wireless communication (such as time resources, frequency resources, and/or spatial resources) may be shared between access links and backhaul links.

In some examples, any network node 110 that relays communications may be referred to as a relay network node, a relay station, or simply as a relay. A relay may receive a transmission of a communication from an upstream station (for example, another network node 110 or a UE 120) and transmit the communication to a downstream station (for example, a UE 120 or another network node 110). In this case, the wireless communication network 100 may include or be referred to as a “multi-hop network.” In the example shown in FIG. 1, the network node 110d (for example, a relay network node) may communicate with the network node 110a (for example, a macro network node) and the UE 120d in order to facilitate communication between the network node 110a and the UE 120d. Additionally or alternatively, a UE 120 may be or may operate as a relay station that can relay transmissions to or from other UEs 120. A UE 120 that relays communications may be referred to as a UE relay or a relay UE, among other examples.

The UEs 120 may be physically dispersed throughout the wireless communication network 100, and each UE 120 may be stationary or mobile. A UE 120 may be, may include, or may be included in an access terminal, another terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, and/or smart jewelry, such as a smart ring or a smart bracelet), an entertainment device (for example, a music device, a video device, and/or a satellite radio), an XR device, a vehicular component or sensor, a smart meter or sensor, industrial manufacturing equipment, a GNSS device (such as a Global Positioning System device or another type of positioning device), a UE function of a network node, and/or any other suitable device or function that may communicate via a wireless medium.

A UE 120 and/or a network node 110 may include one or more chips, system-on-chips (SoCs), chipsets, packages, or devices that individually or collectively constitute or comprise a processing system. The processing system includes processor (or “processing”) circuitry in the form of one or multiple processors, microprocessors, processing units (such as central processing units (CPUs), graphics processing units (GPUs), neural processing units (NPUs) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set, or may include the group of processors all being configured or configurable to perform the set of functions.

The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code (such as software) that, when executed by one or more of the processors, may configure one or more of the processors to perform various functions or operations described herein. Additionally or alternatively, in some examples, one or more of the processors may be preconfigured to perform various functions or operations described herein without requiring configuration by software. The processing system may further include or be coupled with one or more modems (such as a Wi-Fi (for example, Institute of Electrical and Electronics Engineers (IEEE) compliant) modem or a cellular (for example, 3GPP 4G LTE, 5G, or 6G compliant) modem). In some implementations, one or more processors of the processing system include or implement one or more of the modems. The processing system may further include or be coupled with multiple radios (collectively “the radio”), multiple RF chains, or multiple transceivers, each of which may in turn be coupled with one or more of multiple antennas. In some implementations, one or more processors of the processing system include or implement one or more of the radios, RF chains or transceivers. The UE 120 may include or may be included in a housing that houses components associated with the UE 120 including the processing system.

Some UEs 120 may be considered machine-type communication (MTC) UEs, evolved or enhanced machine-type communication (eMTC), UEs, further enhanced eMTC (feMTC) UEs, or enhanced feMTC (efeMTC) UEs, or further evolutions thereof, all of which may be simply referred to as “MTC UEs”. An MTC UE may be, may include, or may be included in or coupled with a robot, an uncrewed aerial vehicle, a remote device, a sensor, a meter, a monitor, and/or a location tag. Some UEs 120 may be considered IoT devices and/or may be implemented as NB-IoT (narrowband IoT) devices. An IoT UE or NB-IoT device may be, may include, or may be included in or coupled with an industrial machine, an appliance, a refrigerator, a doorbell camera device, a home automation device, and/or a light fixture, among other examples. Some UEs 120 may be considered Customer Premises Equipment, which may include telecommunications devices that are installed at a customer location (such as a home or office) to enable access to a service provider's network (such as included in or in communication with the wireless communication network 100).

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, eMBB, and/or precise positioning in the wireless communication network 100, among other examples. A third category of UEs 120 may have mid-tier complexity and/or capability (for example, a capability between UEs 120 of the first category and UEs 120 of the second capability). A UE 120 of the third category may be referred to as a reduced capacity UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, and/or cameras that are associated with a limited bandwidth, power capacity, and/or transmission range, among other examples. RedCap UEs may support healthcare environments, building automation, electrical distribution, process automation, transport and logistics, and/or smart city deployments, among other examples.

In some examples, two or more UEs 120 (for example, shown as UE 120a and UE 120e) may communicate directly with one another using sidelink communications (for example, without communicating by way of a network node 110 as an intermediary). As an example, the UE 120a may directly transmit data, control information, or other signaling as a sidelink communication to the UE 120e. This is in contrast to, for example, the UE 120a first transmitting data in an UL communication to a network node 110, which then transmits the data to the UE 120e in a DL communication. In various examples, the UEs 120 may transmit and receive sidelink communications using peer-to-peer (P2P) communication protocols, device-to-device (D2D) communication protocols, vehicle-to-everything (V2X) communication protocols (which may include vehicle-to-vehicle (V2V) protocols, vehicle-to-infrastructure (V2I) protocols, and/or vehicle-to-pedestrian (V2P) protocols), and/or mesh network communication protocols. In some deployments and configurations, a network node 110 may schedule and/or allocate resources for sidelink communications between UEs 120 in the wireless communication network 100. In some other deployments and configurations, a UE 120 (instead of a network node 110) may perform, or collaborate or negotiate with one or more other UEs to perform, scheduling operations, resource selection operations, and/or other operations for sidelink communications.

In various examples, some of the network nodes 110 and the UEs 120 of the wireless communication network 100 may be configured for full-duplex operation in addition to half-duplex operation. A network node 110 or a UE 120 operating in a half-duplex mode may perform only one of transmission or reception during particular time resources, such as during particular slots, symbols, or other time periods. Half-duplex operation may involve time-division duplexing (TDD), in which DL transmissions of the network node 110 and UL transmissions of the UE 120 do not occur in the same time resources (that is, the transmissions do not overlap in time). In contrast, a network node 110 or a UE 120 operating in a full-duplex mode can transmit and receive communications concurrently (for example, in the same time resources). By operating in a full-duplex mode, network nodes 110 and/or UEs 120 may generally increase the capacity of the network and the radio access link. In some examples, full-duplex operation may involve frequency-division duplexing (FDD), in which DL transmissions of the network node 110 are performed in a first frequency band or on a first component carrier and transmissions of the UE 120 are performed in a second frequency band or on a second component carrier different than the first frequency band or the first component carrier, respectively. In some examples, full-duplex operation may be enabled for a UE 120 but not for a network node 110. For example, a UE 120 may simultaneously transmit an UL transmission to a first network node 110 and receive a DL transmission from a second network node 110 in the same time resources. In some other examples, full-duplex operation may be enabled for a network node 110 but not for a UE 120. For example, a network node 110 may simultaneously transmit a DL transmission to a first UE 120 and receive an UL transmission from a second UE 120 in the same time resources. In some other examples, full-duplex operation may be enabled for both a network node 110 and a UE 120.

In some examples, the UEs 120 and the network nodes 110 may perform MIMO communication. “MIMO” generally refers to transmitting or receiving multiple signals (such as multiple layers or multiple data streams) simultaneously over the same time and frequency resources. MIMO techniques generally exploit multipath propagation. MIMO may be implemented using various spatial processing or spatial multiplexing operations. In some examples, MIMO may support simultaneous transmission to multiple receivers, referred to as multi-user MIMO (MU-MIMO). Some RATs may employ advanced MIMO techniques, such as mTRP operation (including redundant transmission or reception on multiple TRPs), reciprocity in the time domain or the frequency domain, single-frequency-network (SFN) transmission, or non-coherent joint transmission (NC-JT).

In some aspects, a remote UE (e.g., a UE 120) may include a communication manager 140. As described in more detail elsewhere herein, the communication manager 140 may establish a sidelink with a relay UE; transmit a DRX indication that indicates that the remote UE is entering a sidelink DRX cycle that includes one or more active states and one or more sleep states, the one or more active states synchronized with one or more wake-up signal periods; receive a sidelink synchronization signal based at least in part on prioritizing synchronization signals from the relay UE; and monitor, based at least in part on receiving the sidelink synchronization signal, for a wake-up signal in the one or more wake-up signal periods. Additionally, or alternatively, the communication manager 140 may perform one or more other operations described herein.

In some aspects, a relay UE (e.g., a UE 120) may include a communication manager 140. As described in more detail elsewhere herein, the communication manager 140 may establish a sidelink with a remote UE; receive a DRX indication that indicates that the remote UE is entering a sidelink DRX cycle that includes one or more active states and one or more sleep states, the one or more active states synchronized with one or more wake-up signal periods; operate, based at least in part on receiving the DRX indication, as a relay synchronization source for the remote UE; and transmit, based at least in part on operating as the relay synchronization source, a sidelink synchronization signal that is directed to the remote UE. Additionally, or alternatively, the communication manager 140 may perform one or more other operations described herein. In some aspects, the communication manager 140 included in the relay UE is the same communication manager 140 included in the remote UE. That is, a UE 120 may include a communications manager 140 that enables the UE 120 to perform one or more operations of a relay UE and one or more operations of a remote UE.

As indicated above, FIG. 1 is provided as an example. Other examples may differ from what is described with regard to FIG. 1.

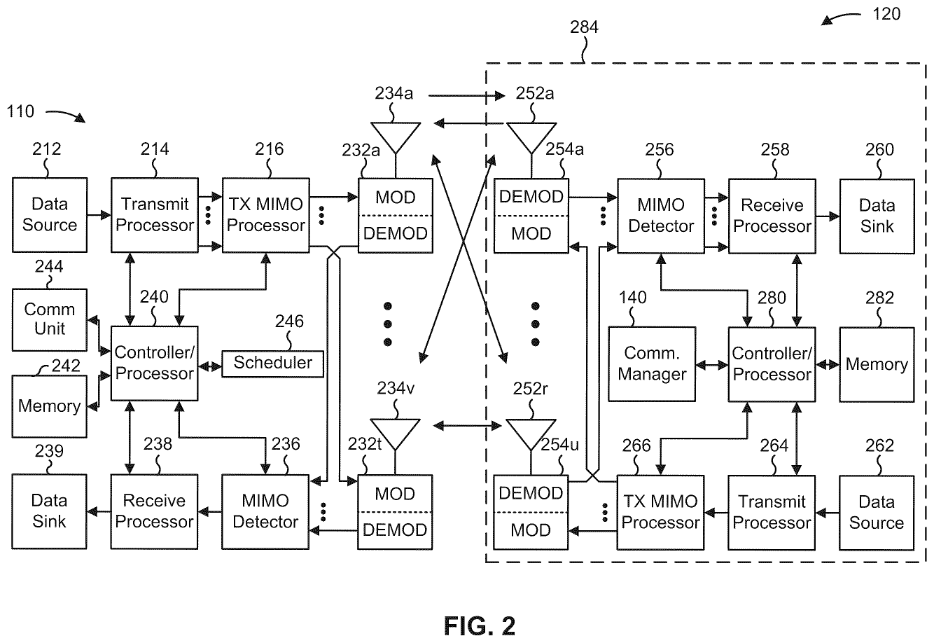

FIG. 2 is a diagram illustrating an example network node 110 in communication with an example UE 120 in a wireless network, in accordance with the present disclosure.

As shown in FIG. 2, the network node 110 may include a data source 212, a transmit processor 214, a transmit (TX) MIMO processor 216, a set of modems 232 (shown as 232a through 232t, where t≥1), a set of antennas 234 (shown as 234a through 234v, where v≥1), a MIMO detector 236, a receive processor 238, a data sink 239, a controller/processor 240, a memory 242, a communication unit 244, and/or a scheduler 246, among other examples. In some configurations, one or a combination of the antenna(s) 234, the modem(s) 232, the MIMO detector 236, the receive processor 238, the transmit processor 214, and/or the TX MIMO processor 216 may be included in a transceiver of the network node 110. The transceiver may be under control of and used by one or more processors, such as the controller/processor 240, and in some aspects in conjunction with processor-readable code stored in the memory 242, to perform aspects of the methods, processes, and/or operations described herein. In some aspects, the network node 110 may include one or more interfaces, communication components, and/or other components that facilitate communication with the UE 120 or another network node.

The terms “processor,” “controller,” or “controller/processor” may refer to one or more controllers and/or one or more processors. For example, reference to “a/the processor,” “a/the controller/processor,” or the like (in the singular) should be understood to refer to any one or more of the processors described in connection with FIG. 2, such as a single processor or a combination of multiple different processors. Reference to “one or more processors” should be understood to refer to any one or more of the processors described in connection with FIG. 2. For example, one or more processors of the network node 110 may include transmit processor 214, TX MIMO processor 216, MIMO detector 236, receive processor 238, and/or controller/processor 240. Similarly, one or more processors of the UE 120 may include MIMO detector 256, receive processor 258, transmit processor 264, TX MIMO processor 266, and/or controller/processor 280.

In some aspects, a single processor may perform all of the operations described as being performed by the one or more processors. In some aspects, a first set of (one or more) processors of the one or more processors may perform a first operation described as being performed by the one or more processors, and a second set of (one or more) processors of the one or more processors may perform a second operation described as being performed by the one or more processors. The first set of processors and the second set of processors may be the same set of processors or may be different sets of processors. Reference to “one or more memories” should be understood to refer to any one or more memories of a corresponding device, such as the memory described in connection with FIG. 2. For example, operation described as being performed by one or more memories can be performed by the same subset of the one or more memories or different subsets of the one or more memories.

For downlink communication from the network node 110 to the UE 120, the transmit processor 214 may receive data (“downlink data”) intended for the UE 120 (or a set of UEs that includes the UE 120) from the data source 212 (such as a data pipeline or a data queue). In some examples, the transmit processor 214 may select one or more modulation and coding schemes (MCSs) for the UE 120 in accordance with one or more channel quality indicators (CQIs) received from the UE 120. The network node 110 may process the data (for example, including encoding the data) for transmission to the UE 120 on a downlink in accordance with the MCS(s) selected for the UE 120 to generate data symbols. The transmit processor 214 may process system information (for example, semi-static resource partitioning information (SRPI)) and/or control information (for example, CQI requests, grants, and/or upper layer signaling) and provide overhead symbols and/or control symbols. The transmit processor 214 may generate reference symbols for reference signals (for example, a cell-specific reference signal (CRS), a demodulation reference signal (DMRS), or a channel state information (CSI) reference signal (CSI-RS)) and/or synchronization signals (for example, a primary synchronization signal (PSS) or a secondary synchronization signals (SSS)).

The TX MIMO processor 216 may perform spatial processing (for example, precoding) on the data symbols, the control symbols, the overhead symbols, and/or the reference symbols, if applicable, and may provide a set of output symbol streams (for example, T output symbol streams) to the set of modems 232. For example, each output symbol stream may be provided to a respective modulator component (shown as MOD) of a modem 232. Each modem 232 may use the respective modulator component to process (for example, to modulate) a respective output symbol stream (for example, for orthogonal frequency division multiplexing (OFDM)) to obtain an output sample stream. Each modem 232 may further use the respective modulator component to process (for example, convert to analog, amplify, filter, and/or upconvert) the output sample stream to obtain a time domain downlink signal. The modems 232a through 232t may together transmit a set of downlink signals (for example, T downlink signals) via the corresponding set of antennas 234.

A downlink signal may include a DCI communication, a MAC control element (CE) communication, an RRC communication, a downlink reference signal, or another type of downlink communication. Downlink signals may be transmitted on a PDCCH, a PDSCH, and/or on another downlink channel. A downlink signal may carry one or more transport blocks (TBs) of data. A TB may be a unit of data that is transmitted over an air interface in the wireless communication network 100. A data stream (for example, from the data source 212) may be encoded into multiple TBs for transmission over the air interface. The quantity of TBs used to carry the data associated with a particular data stream may be associated with a TB size common to the multiple TBs. The TB size may be based on or otherwise associated with radio channel conditions of the air interface, the MCS used for encoding the data, the downlink resources allocated for transmitting the data, and/or another parameter. In general, the larger the TB size, the greater the amount of data that can be transmitted in a single transmission, which reduces signaling overhead. However, larger TB sizes may be more prone to transmission and/or reception errors than smaller TB sizes, but such errors may be mitigated by more robust error correction techniques.

For uplink communication from the UE 120 to the network node 110, uplink signals from the UE 120 may be received by an antenna 234, may be processed by a modem 232 (for example, a demodulator component, shown as DEMOD, of a modem 232), may be detected by the MIMO detector 236 (for example, a receive (Rx) MIMO processor) if applicable, and/or may be further processed by the receive processor 238 to obtain decoded data and/or control information. The receive processor 238 may provide the decoded data to a data sink 239 (which may be a data pipeline, a data queue, and/or another type of data sink) and provide the decoded control information to a processor, such as the controller/processor 240.

The network node 110 may use the scheduler 246 to schedule one or more UEs 120 for downlink or uplink communications. In some aspects, the scheduler 246 may use DCI to dynamically schedule DL transmissions to the UE 120 and/or UL transmissions from the UE 120. In some examples, the scheduler 246 may allocate recurring time domain resources and/or frequency domain resources that the UE 120 may use to transmit and/or receive communications using an RRC configuration (for example, a semi-static configuration), for example, to perform semi-persistent scheduling (SPS) or to configure a configured grant (CG) for the UE 120.

One or more of the transmit processor 214, the TX MIMO processor 216, the modem 232, the antenna 234, the MIMO detector 236, the receive processor 238, and/or the controller/processor 240 may be included in an RF chain of the network node 110. An RF chain may include one or more filters, mixers, oscillators, amplifiers, analog-to-digital converters (ADCs), and/or other devices that convert between an analog signal (such as for transmission or reception via an air interface) and a digital signal (such as for processing by one or more processors of the network node 110). In some aspects, the RF chain may be or may be included in a transceiver of the network node 110.

In some examples, the network node 110 may use the communication unit 244 to communicate with a core network and/or with other network nodes. The communication unit 244 may support wired and/or wireless communication protocols and/or connections, such as Ethernet, optical fiber, common public radio interface (CPRI), and/or a wired or wireless backhaul, among other examples. The network node 110 may use the communication unit 244 to transmit and/or receive data associated with the UE 120 or to perform network control signaling, among other examples. The communication unit 244 may include a transceiver and/or an interface, such as a network interface.

The UE 120 may include a set of antennas 252 (shown as antennas 252a through 252r, where r≥1), a set of modems 254 (shown as modems 254a through 254u, where u≥1), a MIMO detector 256, a receive processor 258, a data sink 260, a data source 262, a transmit processor 264, a TX MIMO processor 266, a controller/processor 280, a memory 282, and/or a communication manager 140, among other examples. One or more of the components of the UE 120 may be included in a housing 284. In some aspects, one or a combination of the antenna(s) 252, the modem(s) 254, the MIMO detector 256, the receive processor 258, the transmit processor 264, or the TX MIMO processor 266 may be included in a transceiver that is included in the UE 120. The transceiver may be under control of and used by one or more processors, such as the controller/processor 280, and in some aspects in conjunction with processor-readable code stored in the memory 282, to perform aspects of the methods, processes, or operations described herein. In some aspects, the UE 120 may include another interface, another communication component, and/or another component that facilitates communication with the network node 110 and/or another UE 120.

For downlink communication from the network node 110 to the UE 120, the set of antennas 252 may receive the downlink communications or signals from the network node 110 and may provide a set of received downlink signals (for example, R received signals) to the set of modems 254. For example, each received signal may be provided to a respective demodulator component (shown as DEMOD) of a modem 254. Each modem 254 may use the respective demodulator component to condition (for example, filter, amplify, downconvert, and/or digitize) a received signal to obtain input samples. Each modem 254 may use the respective demodulator component to further demodulate or process the input samples (for example, for OFDM) to obtain received symbols. The MIMO detector 256 may obtain received symbols from the set of modems 254, may perform MIMO detection on the received symbols if applicable, and may provide detected symbols. The receive processor 258 may process (for example, decode) the detected symbols, may provide decoded data for the UE 120 to the data sink 260 (which may include a data pipeline, a data queue, and/or an application executed on the UE 120), and may provide decoded control information and system information to the controller/processor 280.

For uplink communication from the UE 120 to the network node 110, the transmit processor 264 may receive and process data (“uplink data”) from a data source 262 (such as a data pipeline, a data queue, and/or an application executed on the UE 120) and control information from the controller/processor 280. The control information may include one or more parameters, feedback, one or more signal measurements, and/or other types of control information. In some aspects, the receive processor 258 and/or the controller/processor 280 may determine, for a received signal (such as received from the network node 110 or another UE), one or more parameters relating to transmission of the uplink communication. The one or more parameters may include a reference signal received power (RSRP) parameter, a received signal strength indicator (RSSI) parameter, a reference signal received quality (RSRQ) parameter, a CQI parameter, or a transmit power control (TPC) parameter, among other examples. The control information may include an indication of the RSRP parameter, the RSSI parameter, the RSRQ parameter, the CQI parameter, the TPC parameter, and/or another parameter. The control information may facilitate parameter selection and/or scheduling for the UE 120 by the network node 110.

The transmit processor 264 may generate reference symbols for one or more reference signals, such as an uplink DMRS, an uplink sounding reference signal (SRS), and/or another type of reference signal. The symbols from the transmit processor 264 may be precoded by the TX MIMO processor 266, if applicable, and further processed by the set of modems 254 (for example, for DFT-s-OFDM or CP-OFDM). The TX MIMO processor 266 may perform spatial processing (for example, precoding) on the data symbols, the control symbols, the overhead symbols, and/or the reference symbols, if applicable, and may provide a set of output symbol streams (for example, U output symbol streams) to the set of modems 254. For example, each output symbol stream may be provided to a respective modulator component (shown as MOD) of a modem 254. Each modem 254 may use the respective modulator component to process (for example, to modulate) a respective output symbol stream (for example, for OFDM) to obtain an output sample stream. Each modem 254 may further use the respective modulator component to process (for example, convert to analog, amplify, filter, and/or upconvert) the output sample stream to obtain an uplink signal.

The modems 254a through 254u may transmit a set of uplink signals (for example, R uplink signals or U uplink symbols) via the corresponding set of antennas 252. An uplink signal may include a UCI communication, a MAC-CE communication, an RRC communication, or another type of uplink communication. Uplink signals may be transmitted on a PUSCH, a PUCCH, and/or another type of uplink channel. An uplink signal may carry one or more TBs of data. Sidelink data and control transmissions (that is, transmissions directly between two or more UEs 120) may generally use similar techniques as were described for uplink data and control transmission, and may use sidelink-specific channels such as a physical sidelink shared channel (PSSCH), a physical sidelink control channel (PSCCH), and/or a physical sidelink feedback channel (PSFCH).

One or more antennas of the set of antennas 252 or the set of antennas 234 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 2. As used herein, “antenna” can refer to one or more antennas, one or more antenna panels, one or more antenna groups, one or more sets of antenna elements, or one or more antenna arrays. “Antenna panel” can refer to a group of antennas (such as antenna elements) arranged in an array or panel, which may facilitate beamforming by manipulating parameters of the group of antennas. “Antenna module” may refer to circuitry including one or more antennas, which may also include one or more other components (such as filters, amplifiers, or processors) associated with integrating the antenna module into a wireless communication device.

In some examples, each of the antenna elements of an antenna 234 or an antenna 252 may include one or more sub-elements for radiating or receiving radio frequency signals. For example, a single antenna element may include a first sub-element cross-polarized with a second sub-element that can be used to independently transmit cross-polarized signals. The antenna elements may include patch antennas, dipole antennas, and/or other types of antennas arranged in a linear pattern, a two-dimensional pattern, or another pattern. A spacing between antenna elements may be such that signals with a desired wavelength transmitted separately by the antenna elements may interact or interfere constructively and destructively along various directions (such as to form a desired beam). For example, given an expected range of wavelengths or frequencies, the spacing may provide a quarter wavelength, a half wavelength, or another fraction of a wavelength of spacing between neighboring antenna elements to allow for the desired constructive and destructive interference patterns of signals transmitted by the separate antenna elements within that expected range.

The amplitudes and/or phases of signals transmitted via antenna elements and/or sub-elements may be modulated and shifted relative to each other (such as by manipulating phase shift, phase offset, and/or amplitude) to generate one or more beams, which is referred to as beamforming. The term “beam” may refer to a directional transmission of a wireless signal toward a receiving device or otherwise in a desired direction. “Beam” may also generally refer to a direction associated with such a directional signal transmission, a set of directional resources associated with the signal transmission (for example, an angle of arrival, a horizontal direction, and/or a vertical direction), and/or a set of parameters that indicate one or more aspects of a directional signal, a direction associated with the signal, and/or a set of directional resources associated with the signal. In some implementations, antenna elements may be individually selected or deselected for directional transmission of a signal (or signals) by controlling amplitudes of one or more corresponding amplifiers and/or phases of the signal(s) to form one or more beams. The shape of a beam (such as the amplitude, width, and/or presence of side lobes) and/or the direction of a beam (such as an angle of the beam relative to a surface of an antenna array) can be dynamically controlled by modifying the phase shifts, phase offsets, and/or amplitudes of the multiple signals relative to each other.

Different UEs 120 or network nodes 110 may include different numbers of antenna elements. For example, a UE 120 may include a single antenna element, two antenna elements, four antenna elements, eight antenna elements, or a different number of antenna elements. As another example, a network node 110 may include eight antenna elements, 24 antenna elements, 64 antenna elements, 128 antenna elements, or a different number of antenna elements. Generally, a larger number of antenna elements may provide increased control over parameters for beam generation relative to a smaller number of antenna elements, whereas a smaller number of antenna elements may be less complex to implement and may use less power than a larger number of antenna elements. Multiple antenna elements may support multiple-layer transmission, in which a first layer of a communication (which may include a first data stream) and a second layer of a communication (which may include a second data stream) are transmitted using the same time and frequency resources with spatial multiplexing.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

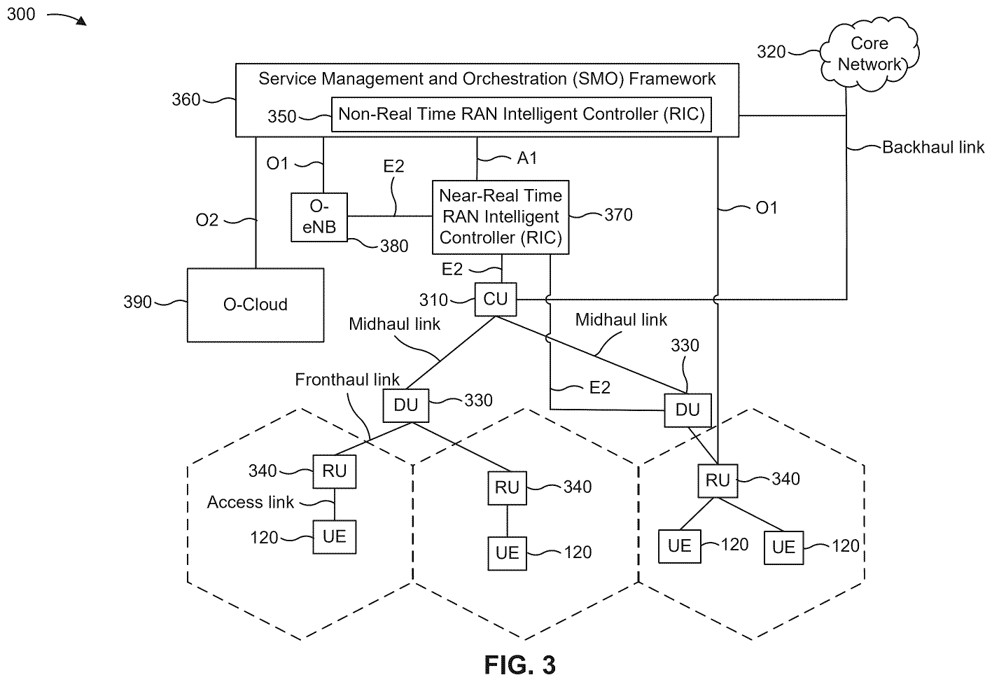

FIG. 3 is a diagram illustrating an example disaggregated base station architecture 300, in accordance with the present disclosure. One or more components of the example disaggregated base station architecture 300 may be, may include, or may be included in one or more network nodes (such one or more network nodes 110). The disaggregated base station architecture 300 may include a CU 310 that can communicate directly with a core network 320 via a backhaul link, or that can communicate indirectly with the core network 320 via one or more disaggregated control units, such as a Non-RT RIC 350 associated with a Service Management and Orchestration (SMO) Framework 360 and/or a Near-RT RIC 370 (for example, via an E2 link). The CU 310 may communicate with one or more DUs 330 via respective midhaul links, such as via F1 interfaces. Each of the DUs 330 may communicate with one or more RUs 340 via respective fronthaul links. Each of the RUs 340 may communicate with one or more UEs 120 via respective RF access links. In some deployments, a UE 120 may be simultaneously served by multiple RUs 340.

Each of the components of the disaggregated base station architecture 300, including the CUs 310, the DUs 330, the RUs 340, the Near-RT RICs 370, the Non-RT RICs 350, and the SMO Framework 360, may include one or more interfaces or may be coupled with one or more interfaces for receiving or transmitting signals, such as data or information, via a wired or wireless transmission medium.

In some aspects, the CU 310 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 310 may be deployed to communicate with one or more DUs 330, as necessary, for network control and signaling. Each DU 330 may correspond to a logical unit that includes one or more base station functions to control the operation of one or more RUs 340. For example, a DU 330 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 330, or for communicating signals with the control functions hosted by the CU 310. Each RU 340 may implement lower layer functionality. In some aspects, real-time and non-real-time aspects of control and user plane communication with the RU(s) 340 may be controlled by the corresponding DU 330.

The SMO Framework 360 may support RAN deployment and provisioning of non-virtualized and virtualized network elements. For non-virtualized network elements, the SMO Framework 360 may support the deployment of dedicated physical resources for RAN coverage requirements, which may be managed via an operations and maintenance interface, such as an O1 interface. For virtualized network elements, the SMO Framework 360 may interact with a cloud computing platform (such as an open cloud (O-Cloud) platform 390) to perform network element life cycle management (such as to instantiate virtualized network elements) via a cloud computing platform interface, such as an O2 interface. A virtualized network element may include, but is not limited to, a CU 310, a DU 330, an RU 340, a non-RT RIC 350, and/or a Near-RT RIC 370. In some aspects, the SMO Framework 360 may communicate with a hardware aspect of a 4G RAN, a 5G NR RAN, and/or a 6G RAN, such as an open eNB (O-eNB) 380, via an O1 interface. Additionally or alternatively, the SMO Framework 360 may communicate directly with each of one or more RUs 340 via a respective O1 interface. In some deployments, this configuration can enable each DU 330 and the CU 310 to be implemented in a cloud-based RAN architecture, such as a vRAN architecture.

The Non-RT RIC 350 may include or may implement a logical function that enables non-real-time control and optimization of RAN elements and resources, AI/ML workflows including model training and updates, and/or policy-based guidance of applications and/or features in the Near-RT RIC 370. The Non-RT RIC 350 may be coupled to or may communicate with (such as via an A1 interface) the Near-RT RIC 370. The Near-RT RIC 370 may include or may implement a logical function that enables near-real-time control and optimization of RAN elements and resources via data collection and actions via an interface (such as via an E2 interface) connecting one or more CUs 310, one or more DUs 330, and/or an O-eNB with the Near-RT RIC 370.

In some aspects, to generate AI/ML models to be deployed in the Near-RT RIC 370, the Non-RT RIC 350 may receive parameters or external enrichment information from external servers. Such information may be utilized by the Near-RT RIC 370 and may be received at the SMO Framework 360 or the Non-RT RIC 350 from non-network data sources or from network functions. In some examples, the Non-RT RIC 350 or the Near-RT RIC 370 may tune RAN behavior or performance. For example, the Non-RT RIC 350 may monitor long-term trends and patterns for performance and may employ AI/ML models to perform corrective actions via the SMO Framework 360 (such as reconfiguration via an O1 interface) or via creation of RAN management policies (such as A1 interface policies).

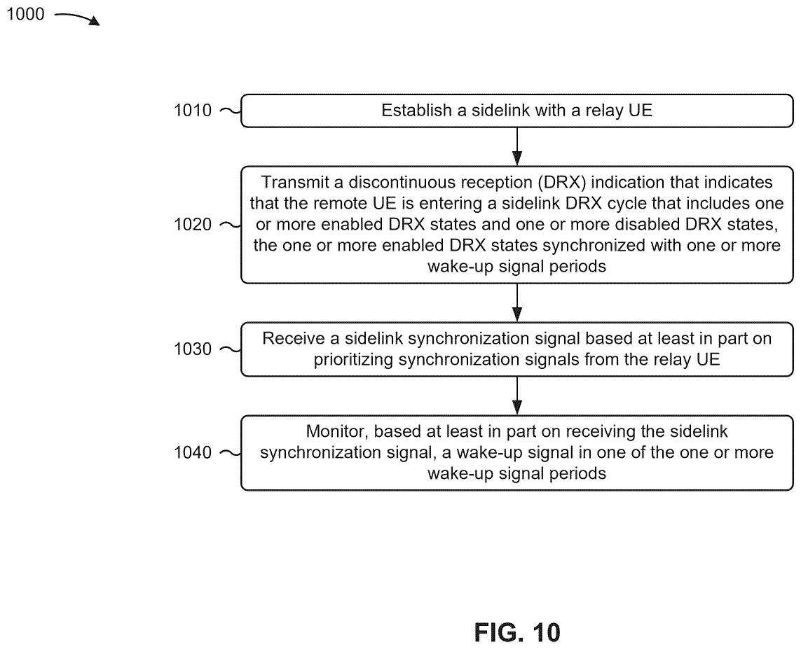

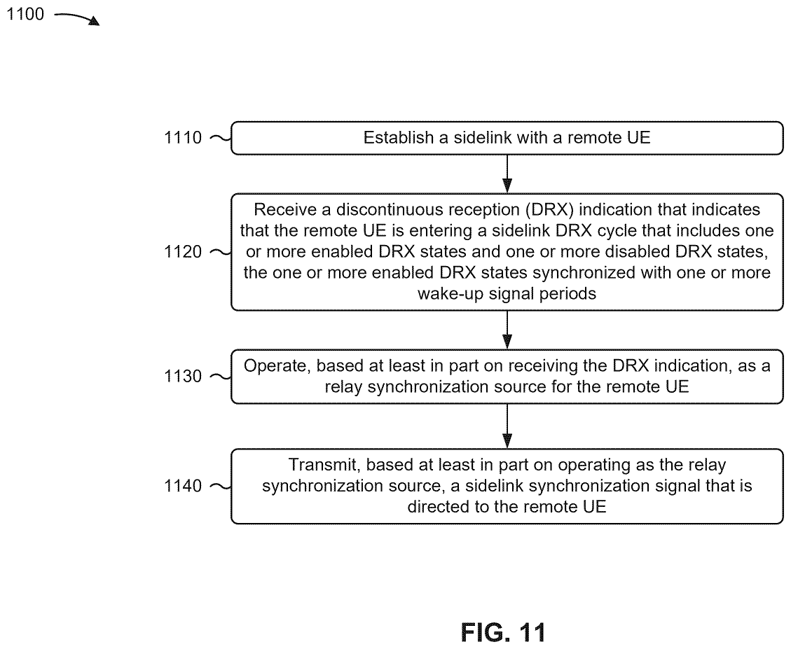

The network node 110, the controller/processor 240 of the network node 110, the UE 120, the controller/processor 280 of the UE 120, the CU 310, the DU 330, the RU 340, or any other component(s) of FIGS. 1, 2, or 3 may implement one or more techniques or perform one or more operations associated with sidelink synchronization signaling, as described in more detail elsewhere herein. For example, the controller/processor 240 of the network node 110, the controller/processor 280 of the UE 120, any other component(s) of FIG. 2, the CU 310, the DU 330, or the RU 340 may perform or direct operations of, for example, process 1000 of FIG. 10, process 1100 of FIG. 11, or other processes as described herein (alone or in conjunction with one or more other processors). The memory 242 may store data and program codes for the network node 110, the network node 110, the CU 310, the DU 330, or the RU 340. The memory 282 may store data and program codes for the UE 120. In some examples, the memory 242 or the memory 282 may include a non-transitory computer-readable medium storing a set of instructions (for example, code or program code) for wireless communication. The memory 242 may include one or more memories, such as a single memory or multiple different memories (of the same type or of different types). The memory 282 may include one or more memories, such as a single memory or multiple different memories (of the same type or of different types). For example, the set of instructions, when executed (for example, directly, or after compiling, converting, or interpreting) by one or more processors of the network node 110, the UE 120, the CU 310, the DU 330, or the RU 340, may cause the one or more processors to perform process 1000 of FIG. 10, process 1100 of FIG. 11, or other processes as described herein. In some examples, executing instructions may include running the instructions, converting the instructions, compiling the instructions, and/or interpreting the instructions, among other examples.

In some aspects, a remote UE (e.g., a UE 120) includes means for establishing a sidelink with a relay UE; means for transmitting a DRX indication that indicates that the remote UE is entering a sidelink DRX cycle that includes one or more active states and one or more sleep states, the one or more active states synchronized with one or more wake-up signal periods; means for receiving a sidelink synchronization signal based at least in part on prioritizing synchronization signals from the relay UE; and/or means for monitoring for wake-up signal in the one or more wake-up signal periods. The means for the remote UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a relay UE (e.g., a UE 120) includes means for establishing a sidelink with a remote UE; means for receiving a DRX indication that indicates that the remote UE is entering a sidelink DRX cycle that includes one or more active states and one or more sleep states, the one or more active states synchronized with one or more wake-up signal periods; means for operating, based at least in part on receiving the DRX indication, as a relay synchronization source for the remote UE; and/or means for transmitting, based at least in part on operating as the relay synchronization source, a sidelink synchronization signal that is directed to the remote UE. The means for the relay UE to perform operations described herein may include, for example, one or more of communication manager 140, antenna 252, modem 254, MIMO detector 256, receive processor 258, transmit processor 264, TX MIMO processor 266, controller/processor 280, or memory 282. In some aspects, the means for the relay UE to perform operations described herein are include in a same UE 120 as the means for the remote UE to perform operation described herein.

As indicated above, FIG. 3 is provided as an example. Other examples may differ from what is described with regard to FIG. 3.

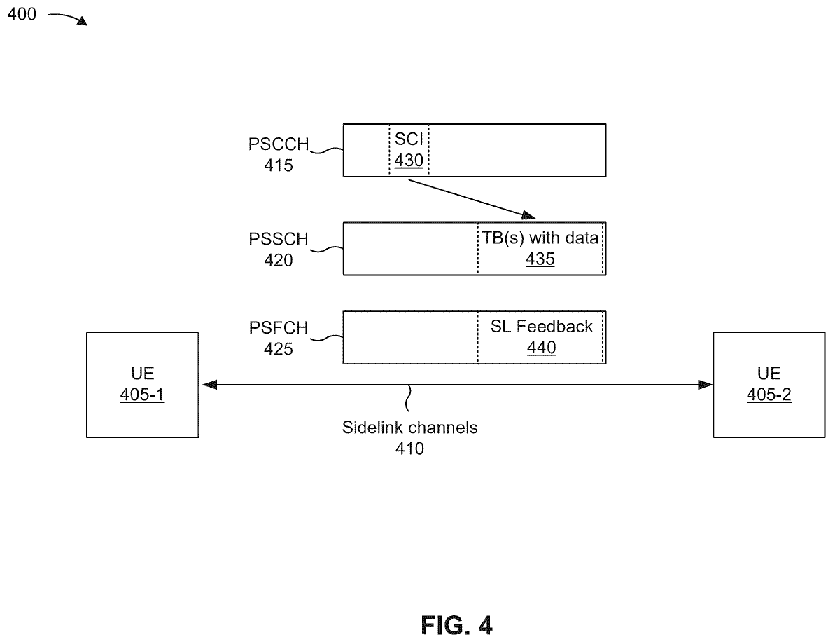

FIG. 4 is a diagram illustrating an example 400 of sidelink communications, in accordance with the present disclosure.

As shown in FIG. 4, a first UE 405-1 may communicate with a second UE 405-2 (and one or more other UEs 405) via one or more sidelink channels 410. The UEs 405-1 and 405-2 may communicate using the one or more sidelink channels 410 for P2P communications, D2D communications, V2X communications (e.g., which may include V2V communications, V2I communications, and/or V2P communications) and/or mesh networking. In some aspects, the UEs 405 (e.g., UE 405-1 and/or UE 405-2) may correspond to one or more other UEs described elsewhere herein, such as UE 120. In some aspects, the one or more sidelink channels 410 may use a PC5 interface and/or may operate in a high frequency band (e.g., the 5.9 GHz band). Additionally, or alternatively, the UEs 405 may synchronize timing of transmission time intervals (TTIs) (e.g., frames, subframes, slots, or symbols) using GNSS timing.

As further shown in FIG. 4, the one or more sidelink channels 410 may include a PSCCH 415, a PSSCH 420, and/or a PSFCH 425. The PSCCH 415 may be used to communicate control information, similar to a PDCCH and/or a PUCCH used for cellular communications with a network node 110 via an access link or an access channel. The PSSCH 420 may be used to communicate data, similar to a PDSCH and/or a PUSCH used for cellular communications with a network node 110 via an access link or an access channel. For example, the PSCCH 415 may carry sidelink control information (SCI) 430, which may indicate various control information used for sidelink communications, such as one or more resources (e.g., time resources, frequency resources, and/or spatial resources) where a TB 435 may be carried on the PSSCH 420. The TB 435 may include data. The PSFCH 425 may be used to communicate sidelink feedback 440, such as hybrid automatic repeat request (HARQ) feedback (e.g., acknowledgement or negative acknowledgement (ACK/NACK) information), TPC, and/or a scheduling request (SR).

Although shown on the PSCCH 415, in some aspects, the SCI 430 may include multiple communications in different stages, such as a first stage SCI (SCI-1) and a second stage SCI (SCI-2). The SCI-1 may be transmitted on the PSCCH 415. The SCI-2 may be transmitted on the PSSCH 420. The SCI-1 may include, for example, an indication of one or more resources (e.g., time resources, frequency resources, and/or spatial resources) on the PSSCH 420, information for decoding sidelink communications on the PSSCH, a quality of service (QoS) priority value, a resource reservation period, a PSSCH DMRS pattern, an SCI format for the SCI-2, a beta offset for the SCI-2, a quantity of PSSCH DMRS ports, and/or an MCS. The SCI-2 may include information associated with data transmissions on the PSSCH 420, such as a HARQ process ID, a new data indicator (NDI), a source identifier, a destination identifier, and/or a CSI report trigger.

In some aspects, the one or more sidelink channels 410 may use resource pools. For example, a scheduling assignment (e.g., included in SCI 430) may be transmitted in sub-channels using specific resource blocks (RBs) across time. In some aspects, data transmissions (e.g., on the PSSCH 420) associated with a scheduling assignment may occupy adjacent RBs in the same subframe as the scheduling assignment (e.g., using frequency division multiplexing). In some aspects, a scheduling assignment and associated data transmissions are not transmitted on adjacent RBs.

In some aspects, a UE 405 may operate using a sidelink transmission mode (e.g., Mode 1) where resource selection and/or scheduling is performed by a network node 110 (e.g., a base station, a CU, or a DU). For example, the UE 405 may receive a grant (e.g., in DCI or in an RRC message, such as for configured grants) from the network node 110 (e.g., directly or via one or more network nodes) for sidelink channel access and/or scheduling. In some aspects, a UE 405 may operate using a transmission mode (e.g., Mode 2) where resource selection and/or scheduling is performed by the UE 405 (e.g., rather than a network node 110). In some aspects, the UE 405 may perform resource selection and/or scheduling by sensing channel availability for transmissions. For example, the UE 405 may measure an RSSI parameter (e.g., a sidelink-RSSI (S-RSSI) parameter) associated with various sidelink channels, may measure an RSRP parameter (e.g., a PSSCH-RSRP parameter) associated with various sidelink channels, and/or may measure an RSRQ parameter (e.g., a PSSCH-RSRQ parameter) associated with various sidelink channels, and may select a channel for transmission of a sidelink communication based at least in part on the measurement(s).

Additionally, or alternatively, the UE 405 may perform resource selection and/or scheduling using SCI 430 received in the PSCCH 415, which may indicate occupied resources and/or channel parameters. Additionally, or alternatively, the UE 405 may perform resource selection and/or scheduling by determining a channel busy ratio (CBR) associated with various sidelink channels, which may be used for rate control (e.g., by indicating a maximum number of resource blocks that the UE 405 can use for a particular set of subframes).

In the transmission mode where resource selection and/or scheduling is performed by a UE 405, the UE 405 may generate sidelink grants, and may transmit the grants in SCI 430. A sidelink grant may indicate, for example, one or more parameters (e.g., transmission parameters) to be used for an upcoming sidelink transmission, such as one or more resource blocks to be used for the upcoming sidelink transmission on the PSSCH 420 (e.g., for TBs 435), one or more subframes to be used for the upcoming sidelink transmission, and/or an MCS to be used for the upcoming sidelink transmission. In some aspects, a UE 405 may generate a sidelink grant that indicates one or more parameters for SPS, such as a periodicity of a sidelink transmission. Additionally, or alternatively, the UE 405 may generate a sidelink grant for event-driven scheduling, such as for an on-demand sidelink message.

As indicated above, FIG. 4 is provided as an example. Other examples may differ from what is described with respect to FIG. 4.

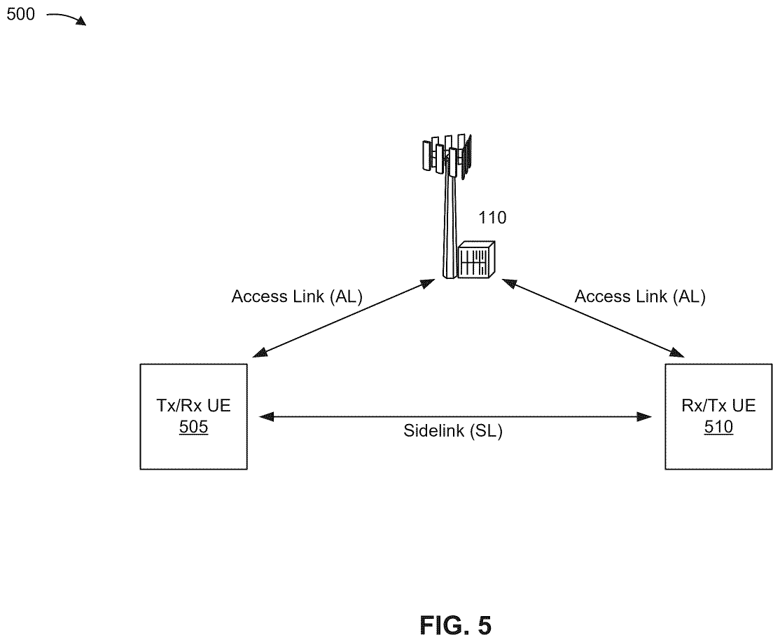

FIG. 5 is a diagram illustrating an example 500 of sidelink communications and access link communications, in accordance with the present disclosure.

As shown in FIG. 5, a transmitter (Tx)/receiver (Rx) UE 505 and an Rx/Tx UE 510 may communicate with one another via a sidelink, as described above in connection with FIG. 4. As further shown, in some sidelink modes, a network node 110 may communicate with the Tx/Rx UE 505 (e.g., directly or via one or more network nodes), such as via a first access link. Additionally, or alternatively, in some sidelink modes, the network node 110 may communicate with the Rx/Tx UE 510 (e.g., directly or via one or more network nodes), such as via a first access link. The Tx/Rx UE 505 and/or the Rx/Tx UE 510 may correspond to one or more UEs described elsewhere herein, such as the UE 120 of FIG. 1. Thus, a direct link between UEs 120 (e.g., via a PC5 interface) may be referred to as a sidelink, and a direct link between a network node 110 and a UE 120 (e.g., via a Uu interface) may be referred to as an access link. Sidelink communications may be transmitted via the sidelink, and access link communications may be transmitted via the access link. An access link communication may be either a downlink communication (from a network node 110 to a UE 120) or an uplink communication (from a UE 120 to a network node 110).

As indicated above, FIG. 5 is provided as an example. Other examples may differ from what is described with respect to FIG. 5.

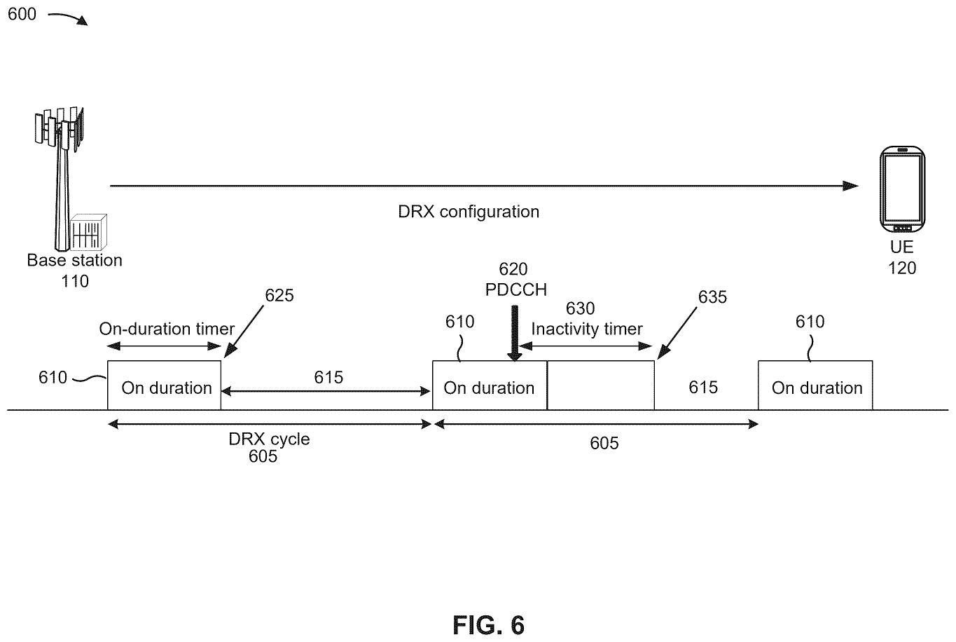

FIG. 6 is a diagram illustrating an example 600 of a DRX configuration, in accordance with the present disclosure.

As shown in FIG. 6, a UE 120 may operate in a DRX cycle 605. In the example 600, the DRX cycle 605 is associated with an access link between the UE 120 and a network node 110 (e.g., an access link DRX cycle), and the network node 110 may transmit a DRX configuration to a UE 120 to configure the DRX cycle 605. While the DRX cycle 605 in the example 600 is described as an access link DRX cycle, the DRX cycle 605 may be associated with a sidelink (e.g., a sidelink DRX cycle 605) in other examples, and the UE 120 may select and/or communicate a DRX configuration for the DRX cycle 605

In the example 600, the DRX cycle 605 includes a DRX on duration 610 (e.g., during which a UE 120 is awake or in an active state) and a DRX off duration 615. The on duration in which the UE 120 is awake may alternatively be referred to as an active state of the UE 120, and the off duration may be referred to as a sleep state of the UE 120. In the active state, the UE 120 may apply an amount of power to a receiver and/or transceiver that enables the UE 120 to receive and/or transmit communications successfully, and, in the sleep state, the UE 120 may reduce an amount of power that is applied to the receiver and/or transceiver. Alternatively, or additionally, the time during which the UE 120 is configured to be in an active state during the DRX on duration 610 may be referred to as an active time, and the time during which the UE 120 is configured to be in the DRX off duration 615 may be referred to as an inactive time. For an access link DRX cycle, the UE 120 may monitor a physical downlink control channel (PDCCH) during the active time, and may refrain from monitoring the PDCCH during the inactive time. For a sidelink DRX cycle, the UE 120 may monitor a PSSCH and/or for SCI during the active time, and may refrain from monitoring the PSSCH and/or for SCI during the inactive time.

To illustrate, as shown by reference number 620, the UE 120 may monitor a downlink control channel (e.g., a PDCCH) during the DRX on duration 610 and/or a sidelink control channel (e.g., a PSCCH). For example, the UE 120 may monitor the PDCCH for DCI pertaining to the UE 120 and/or the PSCCH for SCI pertaining to the UE 120. If the UE 120 does not detect and/or successfully decode any PDCCH communications or PSCCH communications intended for the UE 120 during the DRX on duration 610, then the UE 120 may enter the sleep state during the DRX off duration 615 (e.g., for the inactive time) at the end of the DRX on duration 610, as shown by reference number 625. In this way, the UE 120 may conserve battery power and reduce power consumption. As shown, the DRX cycle 605 may repeat with a configured periodicity according to the DRX configuration.

For an access link DRX cycle, if the UE 120 detects and/or successfully decodes a PDCCH communication intended for the UE 120, then the UE 120 may remain in an active state (e.g., awake) for the duration of a DRX inactivity timer 630 (e.g., which may extend the active time). The UE 120 may start the DRX inactivity timer 630 at a time at which the PDCCH communication is received (e.g., in a TTI in which the PDCCH communication is received, such as a slot or a subframe). The UE 120 may remain in the active state until the DRX inactivity timer 630 expires, at which time the UE 120 may enter a sleep state (e.g., for the DRX off duration 615 and/or inactive time), as shown by reference number 635. During the duration of the DRX inactivity timer 630, the UE 120 may continue to monitor for PDCCH communications, may obtain a downlink data communication (e.g., on a downlink data channel, such as a physical downlink shared channel (PDSCH)) scheduled by the PDCCH communication, and/or may prepare and/or transmit an uplink communication (e.g., on a physical uplink shared channel (PUSCH)) scheduled by the PDCCH communication. The UE 120 may restart the DRX inactivity timer 630 after each detection of a PDCCH communication for the UE 120 for an initial transmission (e.g., but not for a retransmission). By operating in this manner, the UE 120 may conserve battery power and reduce power consumption by entering the sleep state. The UE 120 may perform commensurate actions for a sidelink DRX cycle, such as by remaining active based at least in part on detecting and/or decoding a PSCCH communication intended for the UE 120, starting a DRX inactivity timer based at least in part on receiving and/or decoding the PSCCH communication, entering the sleep state upon expiration of the DRX inactivity time, and/or restarting the DRX inactivity timer after each detection of a PSCCH communication for the UE 120.

As indicated above, FIG. 6 is provided as an example. Other examples may differ from what is described with respect to FIG. 6.

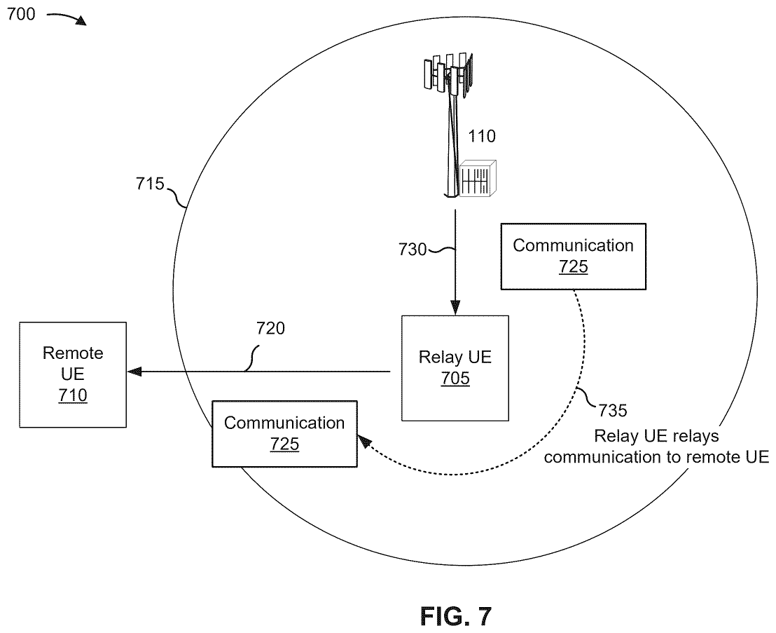

FIG. 7 is a diagram illustrating an example 700 of a relay UE that relays communications between a remote UE and a network node, in accordance with the present disclosure. As shown, example 700 includes a relay UE 705 (e.g., a UE 120), a remote UE 710, and a network node 110. In the example 700, the network node 110 service to the relay UE 705 based at least in part on the relay UE 705 being located in a service coverage area 715 (shown with a dotted line) provide by the network node 110.

In some aspects, the remote UE 710 may communicate indirectly with the network node 110 via the relay UE 705 and a sidelink 720, where the sidelink 720 may also be referred to as an indirect link between the remote UE 710 and network node 110. For example, the network node 110 may transmit a communication 725 (e.g., a data communication) to the relay UE 705 using an access link 730 (e.g., a cellular network link), and, as shown by reference number 735, the relay UE 705 may transmit the communication 725 to the remote UE 710 using the sidelink 720. Accordingly, the communication 725 is transmitted indirectly between the UE 705 and the network node 110 based at least in part on the relay UE 705, and the remote UE 710 may access services from the network node 110 based at least in part on the relay UE 705 forwarding messages from the network node 110 to the remote UE 710 and/or vice versa.

A wireless network may use a relay UE (e.g., the relay UE 705) to extend coverage that is provided to a remote UE (e.g., the remote UE 710), such as in scenarios that include the remote UE operating at an OOC location (e.g., outside of the service coverage area 715 that is provided by the network node 110). As described above, the remote UE may connect to a network node indirectly through the relay UE (e.g., via a sidelink and/or a PC-5 connection), and the relay UE may relay communications between the remote UE and the network node. As one example, the relay UE may perform the relaying of communications in Layer 2 (e.g., an RLC layer) communications. The relaying of communications may include paging communications from the network node that are directed to the remote UE.

As one example, a relay UE may maintain a list of UE identifiers (IDs) for each remote UE that the relay UE services (e.g., performs a relaying operation for). The relay UE may receive a paging message from a network node using an access link, and the paging message may be directed to a remote UE that is connected to and/or serviced by the relay UE. The relay UE may compare an ID included in the paging message with the list of UE IDs to determine if the paging message should be forwarded by the relay UE. Based at least in part on locating a matching UE ID in the list, the relay UE may relay the paging message to the remote UE via a sidelink.

In some cases, the relay UE may operate in an RRC IDLE mode and/or an RRC INACTIVE mode in a same duration that the remote UE operates in the RRC IDLE mode and/or the RRC INACTIVE mode. In such a case, the relay UE may monitor paging occasions (e.g., on the access link) of the remote UE. In other cases, the relay UE may operate in an RRC CONNECTED mode in a same duration that the remote UE operates in the RRC IDLE mode and/or the RRC INACTIVE mode. For such a case, the relay UE may monitor a paging occasion for the remote UE and/or may receive a dedicated RRC message (e.g., a paging delivery message) from the network node. Based at least in part on receiving a page via a paging occasion or dedicated RRC message, the relay UE may forward the page to the remote UE using the sidelink.

As indicated above, FIG. 7 is provided as an example. Other examples may differ from what is described with respect to FIG. 7.

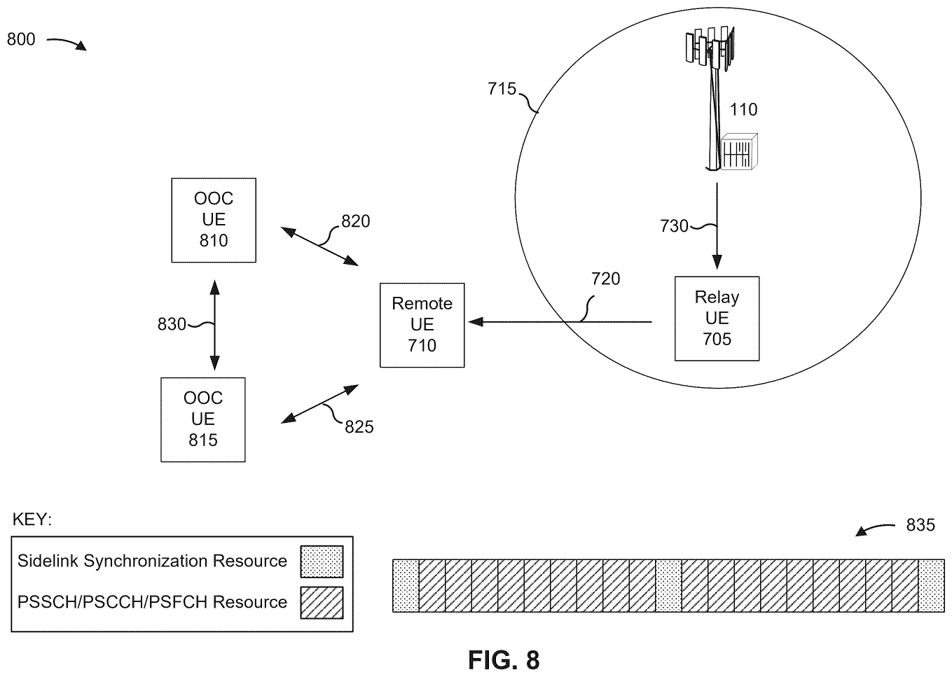

FIG. 8 is a diagram illustrating an example 800 of sidelink synchronization, in accordance with the present disclosure.

“Sidelink synchronization” may denote a process in which UEs that are connected to one another (e.g., via a sidelink) establish and maintain timing and/or frequency alignment to enable reliable communications (e.g., the transmission and/or receipt of information with minimal errors) between the UEs. To illustrate, the example 800 shown by FIG. 8 includes the network node 110 that provides the service coverage area 715 and indirectly communicates with the remote UE 710 using the relay UE 705. The network node 110 and the relay UE 705 communicate via the access link 730, and the relay UE 705 and the remote UE 710 communicate via the sidelink 720. As one example, the relay UE 705 may maintain synchronization with the network node 110 (e.g., access link synchronization) based at least in part on one or more synchronization signals (e.g., a PSS and/or an SSS) transmitted by the network node 110 via the access link 730, and the remote UE 710 may maintain synchronization with the relay UE 705 (e.g., sidelink synchronization) using one or more synchronization signals (e.g., a primary sidelink synchronization signal (PSSS) and/or a secondary sidelink synchronization signal (SSSS)) transmitted by the relay UE 705 using the sidelink 720.

As another example, the remote UE 710 may alternatively, or additionally, be connected to other OOC UEs via respective sidelinks. In the example 800, the remote UE 710 connects to a first OOC UE 810 using a sidelink 815, and a second OOC UE 820 using a sidelink 825. As shown by FIG. 8, the first OOC UE 810 and the second OOC UE 820 may be directly connected to one another using a sidelink 830. In some aspects, the relay UE 705 and the remote UE 710 may maintain sidelink synchronization using synchronization signals from one of the OOC UEs (e.g., the first OOC UE 810 and/or the second OOC UE 820) based at least in part on the OOC UE having a strong GNSS link and GNSS synchronization having a higher priority than a network node synchronization. To illustrate, the first OOC UE 810 may receive a GNSS signal, and the GNSS signal may have a received power level that satisfies a threshold. Based at least in part on GNSS synchronization having a higher priority relative to network node synchronization, the remote UE 710 and/or the relay UE 705 may maintain sidelink synchronization using one or more synchronization signals transmitted by the first OOC UE 810. Accordingly, a UE may synchronize an access link using synchronization signals from a network node, and may synchronize a sidelink using synchronization signals from another UE.

In some cases, sidelink UEs that are connected to one another via a unicast sidelink may not be synchronization sources for one another. To illustrate, the remote UE 710 and the first OOC UE 810 may be sidelink unicast peers of one another based at least in part on establishing a unicast sidelink with one another (e.g., the sidelink 815). In some aspects, the first OOC UE 810 is not a sidelink synchronization source for the remote UE 710, and the remote UE 710 is not a sidelink synchronization source for the first OOC UE 810. Instead, the first OOC UE 810 and the remote UE 710 may maintain sidelink synchronization with one another using a common sidelink synchronization source. Examples of a common sidelink synchronization source may include a network node (e.g., the network node 110), a GNSS source, and/or another UE, such as the second OOC UE 820.

Sidelink resources in a sidelink pool may have different assignments and/or may be dedicated to different transmissions. To illustrate, a sidelink resource pool 835 includes a combination of sidelink resources (e.g., frequency domain resources, time domain resources, spatial domain resources, and/or code domain resources) that are dedicated to sidelink synchronization signals (shown with a dotted pattern) and sidelink resources that are dedicated to PHY layer signals (shown with diagonal stripes). Examples of PHY layer signals may include PSSCH transmissions, PSCCH transmissions, and/or PSFCH transmissions. Accordingly, within the sidelink resource pool 835, PHY layer sidelink resources are separate from sidelink synchronization resources, where the sidelink synchronization resource are shown by FIG. 8 as being periodic sidelink resources (e.g., periodic physical slots) that are separated from the PHY layer sidelink resources, and a sidelink synchronization procedure performed by a UE using the sidelink synchronization resources is a separate process from other sidelink communications and/or sidelink procedures that use the PHY layer sidelink resources.

At times, a UE (e.g., the remote UE 710 and/or the relay UE 705) may determine that a loss of sidelink synchronization has occurred based at least in part on detecting a failure in a connection maintenance procedure (e.g., failure in a keep-alive procedure). Accordingly, the UE may change from using a first sidelink synchronization source (e.g., a first UE, a network node, and/or a GNSS source) to a second sidelink synchronization source (e.g., a second UE, another network node, and/or another GNSS source). Switching between sidelink synchronization sources may be governed by rules, such as rules specified by a communication standard and/or rules configured by a network node. As one example rule, if a remote UE (e.g., an OOC UE) is currently synchronized with a relay UE using a particular sidelink synchronization source (e.g., a common GNSS source, a common network node source, a common UE source, and/or the relay UE), the remote UE will continue to use the particular sidelink synchronization source unless the remote UE locates a higher priority sidelink synchronization source and/or unless the particular synchronization source becomes unreliable (e.g., a received signal power level of the particular sidelink synchronization source fails to satisfy a strong threshold). As another example rule, the UE may avoid selecting a sidelink synchronization signal (e.g., from a particular OOC UE and/or a different relay UE) only using a signal metric of the sidelink synchronization signal to mitigate unnecessary and/or frequency sidelink synchronization signal reselections and/or relay UE reselections. In some scenarios, these selection rules for a sidelink synchronization signal may pose some challenges for an OOC remote UE.

To illustrate, a UE (e.g., the remote UE 710 and/or the relay UE 705) may operate in a DRX cycle to save power as described with regard to FIG. 6. For instance, the remote UE 710 may operate in a sidelink DRX cycle and/or the relay UE 705 may operate in a sidelink DRX cycle and/or an access link DRX cycle. As at least part of operating in the sidelink DRX cycle, the UE may monitor for sidelink synchronization signals as part of transitioning to and/or operating in an active duration of the sidelink DRX cycle, such as by monitoring sidelink synchronization signal resources. In some cases, a sidelink configuration used by the UE may prioritize a GNSS-based sidelink synchronization source higher than a network-node-based sidelink synchronization source, such as in an OOC V2X operating scenario. Based at least in part on UE-mobility, the UE (e.g., the remote UE 710) may fail to detect and/or lose the higher priority sidelink synchronization source that is used as a common sidelink synchronization source (e.g., between the remote UE and the relay UE). For instance, the remote UE 710 may lose the higher priority sidelink synchronization source (e.g., the GNSS-based sidelink synchronization source) and may synchronize to another UE (e.g., the first OOC UE 810 and/or the second OOC UE 820). However, the relay UE 705 relaying messages to and from the remote UE 710 may still detect and/or maintain the higher priority sidelink synchronization source. Other scenarios may also result in a mismatch of sidelink synchronization sources between a relay UE and a remote UE, such as a blockage at one of UEs that is due to a moving object (e.g., a truck and/or a tree) or a blockage due to a hand placement on the UE. Based at least in part on not operating with a DRX cycle (e.g., the remote UE is actively transmitting and/or receiving communications with the relay UE), the mismatch of sidelink synchronization sources may be identified by the remote UE and/or the relay UE quickly based at least in part on link-level measurement metrics. However, based at least in part on operating in a DRX cycle, the remote UE and/or the relay UE may operate in an inactive state for multiple durations and/or long durations that result in sidelink synchronization loss. That is, the remote UE and/or the relay UE may often experience a loss in sidelink synchronization with one another, resulting in a dropped sidelink connection, an increase in data recovery errors in the sidelink, a decrease in data throughput in the sidelink, and/or an increase in data transfer latency in the sidelink.

As another example, a relay UE (e.g., the relay UE 705) may operate in an RRC IDLE state while a remote UE (e.g., the UE 710) connected to the relay UE operates in a sidelink DRX cycle. To page the remote UE through the relay UE, a network node (e.g., network node 110) may use a paging cycle that is not synchronized with the sidelink DRX cycle of the remote UE. In some aspects, the relay UE and the remote UE may support an advance wake-up signal, such as a low-power wake-up signal (LP-WUS) or a paging early indicator that the relay UE transmits, and the remote UE receives, via the sidelink. However, and in a similar manner as described above, the sidelink synchronization between the relay UE and the remote UE may be mismatched. That is, the sidelink synchronization between the relay UE and the remote UE may not be guaranteed in a scenario in which the remote UE is using a DRX cycle, resulting in an unreliable advance wake-up that the remote UE fails to receive and/or relayed messages that the remote UE fails to receive.

Various aspects relate generally to sidelink synchronization signaling. Some aspects more specifically relate to a remote UE that is operating in a sidelink DRX cycle prioritizing a synchronization signal from a relay UE that is connected to the remote UE via a sidelink. In some aspects, a remote UE may establish a sidelink with a relay UE. The remote UE may transmit (e.g., via a sidelink) a DRX indication that indicates that the remote UE is entering a sidelink DRX cycle, and the sidelink DRX cycle may include one or more active states and one or more sleep states, where the one or more active states may be synchronized with one or more wake-up signal periods. The remote UE may receive a wake-up signal in one of the one or more wake-up signal periods. Based at least in part on receiving the wake-up signal, the remote UE may monitor for a sidelink synchronization signal based at least in part on prioritizing synchronization signals from the relay UE.

In some aspects, a relay UE may establish a sidelink with a remote UE. The relay UE may receive a DRX indication that indicates that the remote UE is entering a sidelink DRX cycle that includes one or more active states and one or more sleep states, where the one or more active states may be synchronized with one or more wake-up signal periods. Based at least in part on receiving the DRX indication, the relay UE may operate as a relay synchronization source for the remote UE, and operating as a relay synchronization source may include the relay UE transmitting, a wake-up signal in one of the wake-up signal periods and transmitting a sidelink synchronization signal that is directed to the remote UE.

Particular aspects of the subject matter described in this disclosure can be implemented to realize one or more of the following potential advantages. In some examples, by prioritizing a synchronization signal from a relay UE, the described techniques can be used to enable a remote UE to mitigate a mismatch in sidelink synchronization with the relay UE. Mitigating a mismatch in sidelink synchronization between a remote UE and a relay UE may mitigate a dropped sidelink connection, may decrease data recovery errors in the sidelink, may increase data throughput in the sidelink, and/or may decrease data transfer latency in the sidelink.

As indicated above, FIG. 8 is provided as an example. Other examples may differ from what is described with regard to FIG. 8.

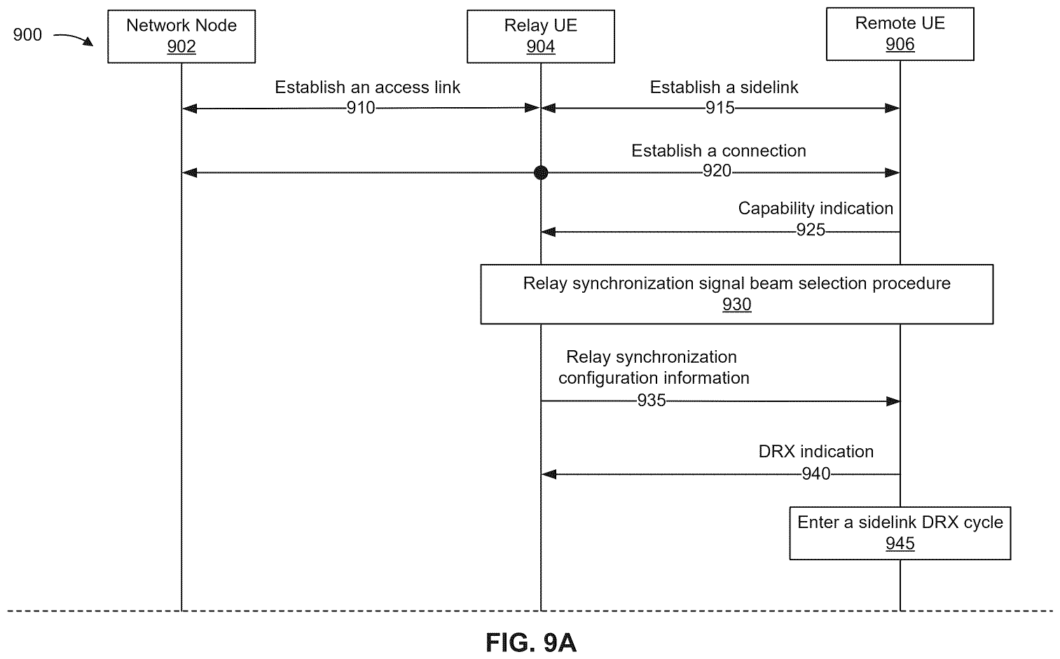

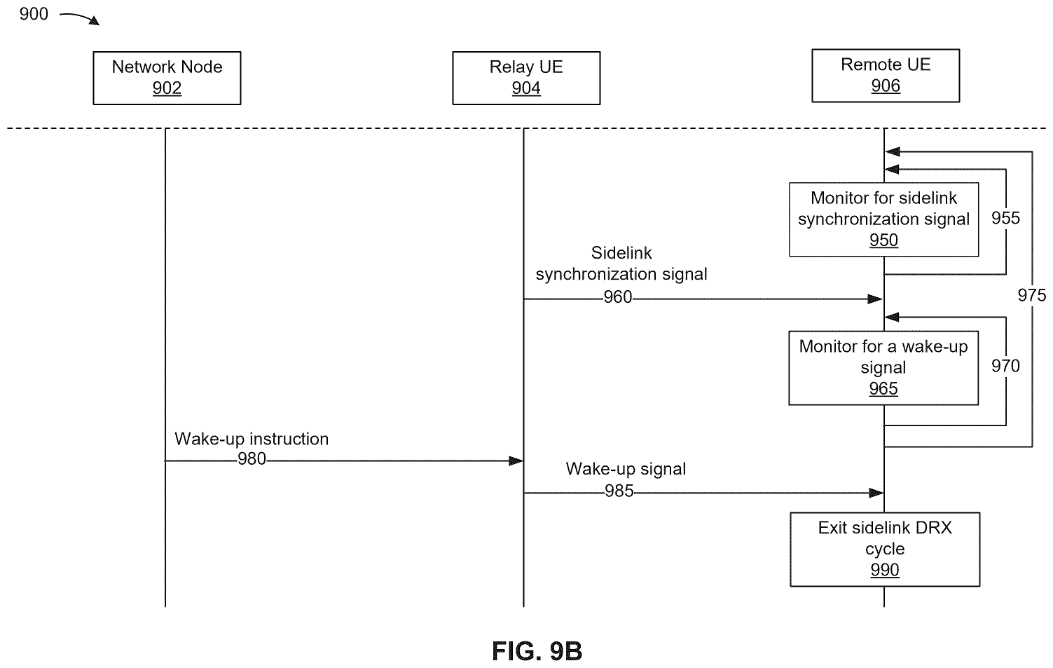

FIGS. 9A and 9B, collectively, illustrate a diagram of an example wireless communication process 900 between a network node 902 (e.g., the network node 110), a relay UE 904 (e.g., a first UE 120), and a remote UE 906 (e.g., a second UE 120), in accordance with the present disclosure.

The wireless communication process 900 begins in FIG. 9A. As shown by reference number 910, a network node 902 and a relay UE 904 may establish an access link. To illustrate, the relay UE 904 may power up in a service coverage area provided by the network node 902, and the relay UE 904 and the network node 902 may perform one or more procedures (e.g., a random access channel (RACH) procedure and/or an RRC procedure) to establish an access link. As another example, the relay UE 904 may move into the service coverage area provided by the network node 902 and may perform a handover from a source network node (e.g., another network node 110) to the network node 902. Alternatively, or additionally, the network node 902 and the relay UE 904 may communicate via the access link based at least in part on any combination of Layer 1 signaling (e.g., DCI and/or UCI), Layer 2 signaling (e.g., a MAC CE), and/or Layer 3 signaling (e.g., RRC signaling). To illustrate, the network node 902 may request, via RRC signaling, UE capability information and/or the relay UE 904 may transmit, via RRC signaling, the UE capability information. As part of communicating via the connection, the network node 902 may transmit configuration information via Layer 3 signaling (e.g., RRC signaling), and activate and/or deactivate a particular configuration via Layer 2 signaling (e.g., a MAC CE) and/or Layer 1 signaling (e.g., DCI). To illustrate, the network node 902 may transmit the configuration information via Layer 3 signaling at a first point in time associated with the relay UE 904 being tolerant of communication delays, and the network node 902 may transmit an activation of the configuration via Layer 2 signaling and/or Layer 1 signaling at a second point in time associated with the relay UE 904 being intolerant to communication delays.

As shown by reference number 915, the relay UE 904 and a remote UE 906 may establish a sidelink. To illustrate, the relay UE 904 may iteratively and/or periodically transmit a sidelink discovery message that the remote UE 906 receives and/or detects (or vice versa). The relay UE 904 and the remote UE 906 may establish a sidelink with one another using sidelink air interface resources (e.g., Mode 1 sidelink air interface resources allocated the network node 902 and/or Mode 2 sidelink air interface resources that are autonomously managed and/or selected by the relay UE 904 and the remote UE 906). The relay UE 904 and the remote UE 906 may establish the sidelink based at least in part on using SCI. As part of establishing the sidelink, the relay UE 904 and the remote UE 906 may synchronize to a common time source (e.g., GNSS, the relay UE 904, the remote UE 906, and/or the network node 902). In some aspects, the remote UE 906 may operate as an OOC UE relative to the network node 902.

As shown by reference number 920, the remote UE 906 and the network node 902 may establish a connection based at least in part on the relay UE 904. For instance, based at least in part on establishing a sidelink with the relay UE 904, the remote UE 906 may use the relay UE 904 to establish a connection with the network node 902. Alternatively, or additionally, the network node 902 may configure the relay UE 904 as a proxy for the remote UE 906, and the relay UE 904 may relay control plane signaling and/or user plane data between the network node 902 and the remote UE 906.

As shown by reference number 925, the remote UE 906 may transmit, and the relay UE 904 may receive, capability information. For instance, the capability information may indicate that the remote UE supports reception of a low power (LP) SSBs (e.g., an SSB with a reduced signal power level relative to another SSB). An example of an LP SSB may be an SSB that is transmitted with a power level within a first range of −10 to 0 decibel milliwatts (dBm), and an example of a non-LP SSB may be an SSB that is transmitted with a power level within a second range of 20 to 40 dBm. The non-LP SSB may also be referred to as a standard SSB. Alternatively, or additionally, the remote UE 906 may indicate support for an LP radio unit (e.g., an LP radio unit for sidelink communications), such as a radio unit that is optimized to receive low power signals (e.g., signals with a power level that satisfies a low signal power level threshold), is optimized to operate with low power consumption (e.g., the radio unit is powered by and/or consumes an amount of power that satisfies a low power consumption threshold), and/or is optimized to be used by a UE that is operating in a power saving mode (e.g., a DRX cycle).

As shown by reference number 930, the relay UE 904 and the remote UE 906 may perform a relay synchronization signal beam selection procedure. For instance, the remote UE 906 and the relay UE 904 may be configured to communicate via the sidelink using one or more beams and/or one or more beamformed transmissions. Based at least in part on communication via the sidelink using the beam(s), the relay UE 904 and the remote UE 906 may perform the relay synchronization signal beam selection procedure. Alternatively, or additionally, the relay UE 904 and the remote UE 906 may perform the relay synchronization signal beam selection signal based at least in part on the relay UE 904 acting as a relay between the network node 902 and the remote UE 906.

As part of the relay synchronization signal beam selection procedure, the relay UE 904 and/or the remote UE 906 may generate one or more signal quality measurement metrics (e.g., RSSI, RSRP, and/or a CQI) on data transmissions, and may use the signal quality measurement metrics to select one or more relay synchronization signals beams. In some aspects, the relay UE 904 and/or the remote UE 906 may generate the signal quality measurement metrics using one or more sidelink data transmissions. As one example, the remote UE 906 may select three potential relay synchronization signal beams, and may indicate the three potential relay synchronization signal beams to the relay UE 904. The relay UE 904 may select one of the three potential relay synchronization signal beams, and indicate the selected relay synchronization signal beams and/or may indicate an instruction (e.g., to the remote UE 906) to use the selected relay synchronization signal beams to monitor for a relay synchronization signal. Alternatively, or additionally, the remote UE 906 may select a final relay synchronization signal beam (e.g., instead of a potential beam), and indicate the selected relay synchronization signal beam to the relay UE 904.

As part of the relay synchronization signal beam selection procedure, the relay UE 904 and/or the remote UE 906 may iterate through multiple beams, such as multiple sidelink transmit beams and/or multiple sidelink receive beams, and may generate a respective measurement metric for each pairing (e.g., at a receive-side UE). For instance, the relay UE 904 may iterate through multiple sidelink transmit beams to transmit a reference signal and/or a data transmission, and the remote UE 906 may generate a respective measurement metric for each sidelink transmit beam. Alternatively, or additionally, the remote UE 906 may iterate through multiple sidelink receive beams, and may generate a respective measurement metric for each sidelink receive beam. The remote UE 906 may indicate at least some of the measurement metrics to the relay UE 904, and the relay UE 904 may select one or more relay synchronization signal beams (e.g., a sidelink transmit beam, a sidelink receive beam, and/or a sidelink beam pair that includes a sidelink transmit beam and a sidelink receive beam) to use to transmit and/or receive a relay synchronization signal. The relay UE 904 may indicate the selected relay synchronization signal beam(s) to the remote UE 906.

In some aspects, the remote UE 906 may analyze the measurement metrics and may select one or more relay synchronization signal beams, such as by selecting the top X sidelink beams associated with the highest signal quality metrics (X being an integer). For instance, the remote UE 906 may select a sub-group of beams from multiple sidelink beams being analyzed for selection as a relay synchronization signal beams. The remote UE 906 may indicate the X sidelink beams as final beam selection(s) for relay synchronization signal beam(s) and/or with an indication to use the final beam selection(s) as the relay synchronization signal beam(s). Alternatively, or additionally, the remote UE 906 may indicate the X sidelink beams as proposed relay synchronization signal beams, and the relay UE 904 may select a relay synchronization signal beam from the proposed relay synchronization signal beams. Accordingly, the relay UE 904 and the remote UE 906 may jointly select one or more relay synchronization signal beams to use for transmission (e.g., by the relay UE 904) and/or reception (e.g., by the remote UE 906) of a sidelink synchronization signal.

As shown by reference number 935, the relay UE 904 may transmit, and the remote UE 906 may receive, relay synchronization signal configuration information. The relay UE 904 may transmit the relay synchronization signal configuration information in a single transmission and/or may use multiple transmissions. An example of multiple transmissions may include a first transmission that indicates a portion of the relay synchronization signal configuration information in RRC signaling and a second transmission that indicates a portion of the relay synchronization signal configuration information in SCI. In some aspects, the relay UE 904 may transmit, as at least a portion of the relay synchronization signal configuration information, scheduling information for one or more relay synchronization resources that are associated with and/or assigned to the sidelink synchronization signal. The relay synchronization resources indicated in the relay synchronization signal configuration information may be dedicated to a sidelink synchronization signal from the relay UE 904 that is directed to the remote UE 906 and/or may be different from one or more pre-configured sidelink SSB synchronization resources.

To illustrate, pre-configured sidelink SSB synchronization resources may be pre-configured by a wireless network and/or a communication standard. In some aspects, pre-configured sidelink SSB synchronization resources may be used by any UE connected to a sidelink based at least in part on one or more operating conditions, such as an operating condition that the UE is compliant with the communication standard. The relay synchronization resources indicated in the relay synchronization signal configuration information may be dedicated to a sidelink synchronization signal between the relay UE 904 to remote UE 906, and other UEs may not be allowed to use the relay synchronization resources and/or a sidelink synchronization signal that uses the dedicated relay synchronization resources.

Alternatively, or additionally, the relay synchronization signal configuration information may include an instruction, such as an instruction to monitor for a sidelink SSB and/or for a sidelink LP SSB as the sidelink synchronization signal. In some aspects, the relay synchronization signal configuration information may indicate that the sidelink synchronization signal is an LP SSB and/or may indicate to monitor for the LP SSB using an LP sidelink radio unit, such as in a scenario where the remote UE 906 indicates support for an LP radio unit.

In some aspects, the relay synchronization signal configuration information may include beam selection configuration information that may be used by the remote UE 906 to select one or more updated relay synchronization signal beam(s). Examples of beam selection configuration information may include reference signal configuration information (e.g., that pre-configures one or more reference signals) and/or one or more beam configurations.

Alternatively, or additionally, the relay UE 904 may indicate, in the relay synchronization configuration information, wake-up signal configuration information. As one example, the relay UE 904 may indicate a wake-up signal identifier that is assigned to the remote UE 906, and the wake-up signal identifier may include a group ID and/or a sequence ID. To illustrate, the relay UE 904 may be connected to multiple UEs (including the remote UE 906) using respective sidelinks to each UE. The relay UE 904 may divide the multiple UEs into sub-groups and assign a group ID and/or a sequence ID to each sub-group. The relay UE 904 may indicate the group ID and/or sequence ID assigned to the remote UE 906 in the wake-up signal configuration information and/or may indicate to search for the group ID and/or sequence ID in a wake-up signal. The use of a wake-up signal identifier (e.g., the group ID and/or sequence ID) may enable the relay UE 904 to communicate, and the remote UE 906 to detect, a wake-up signal that is directed to the remote UE 906. The relay UE 904 may indicate one or more air interface resources (e.g., a frequency resource and/or a time resource) that may be used to carry the wake-up signal. Alternatively, or additionally, the relay UE 904 may indicate to monitor for an LP wake-up signal.

As shown by reference number 940, the remote UE 906 may transmit, and the relay UE 904 may receive, a DRX indication, and the DRX indication may indicate that the remote UE 906 is entering a sidelink DRX cycle, such as a sidelink DRX cycle as described with regard to FIG. 6. The sidelink DRX cycle used by the remote UE 906 may include one or more active states (e.g., active durations) and/or one or more sleep states (e.g., inactive durations). The active states may be synchronized with one or more wake-up signal periods (e.g., on durations used to monitor for a wake-up signal).

Based at least in part on receiving the DRX indication, the relay UE 904 may operate as a sidelink synchronization source for the remote UE. That is, receiving the DRX indication may trigger the relay UE 904 to begin operating as a sidelink synchronization source for the remote UE 906, and the relay UE 904 may derive synchronization reference timing information that is used for and/or as a sidelink synchronization source between the relay UE 904 and the remote UE 906. As one example, the relay UE 904 may derive the synchronization reference timing information from a network node serving the relay UE 904 (e.g., the network node 902). As another example, the relay UE 904 may derive synchronization reference timing information from a GNSS and/or a current sidelink synchronization reference source of the relay UE 904 (e.g., another UE and/or another network node). The relay UE 904 may select a synchronization timing source (e.g., the network node, a GNSS, another UE, and/or the current sidelink synchronization reference source) based at least in part on a prioritization, such as a prioritization specified by a communication standard and/or configured by the network node 902. For instance, based at least in part on operating as a sidelink synchronization source for a UE operating in a DRX mode (e.g., the remote UE 906), the relay UE 904 may prioritize a GNSS timing source higher than a network node source (e.g., the network node 902), or vice versa. In some aspects, the relay UE 904 may use a prioritized list that assigns a respective synchronization source priority to a GNSS timing source, a network node timing source, and/or a UE timing source, and the relay UE 904 may select the highest priority synchronization source to use for deriving synchronization reference timing information that is used for and/or as a sidelink synchronization source.

Deriving the synchronization reference timing information may include the relay UE 904 monitoring for one or more synchronization signals from one or more potential sidelink synchronization sources. Alternatively, or additionally, the relay UE 904 may generate a respective signal quality metric for each potential sidelink synchronization source and select a sidelink synchronization source based at least in part on a signal quality metric (e.g., by selecting a sidelink synchronization source with a best signal quality metric). In some aspects, deriving the synchronization reference timing information from sidelink synchronization source may include deriving frame timing information and/or subframe timing information based at least in part on monitoring one or more signals from the sidelink synchronization source (e.g., a PSS, an SSS, a PSSS, an SSSS, and/or a GNSS-based synchronization signal).

As shown by reference number 945, the remote UE 906 may enter a sidelink DRX cycle. That is, the remote UE 906 may operate using a sidelink DRX cycle and, as part of operating using a sidelink DRX cycle, the remote UE 906 may transition between a sleep state and an active state as described with regard to FIG. 6. In some aspects, the sidelink DRX cycle may be synchronized with one or more wake-up periods (e.g., one or more occasions for a wake-up signal) such that an active state is synchronized, overlaps, and/or is aligned in time with a wake-up period.

The wireless communication process 900 proceeds from FIG. 9A to FIG. 9B. As shown by reference number 950, the remote UE 906 may monitor for a sidelink synchronization signal. In some aspects, the remote UE 906 may monitor for the sidelink synchronization signal in the (dedicated) relay synchronization resources as described with regard to reference number 935. Alternatively, or additionally, the remote UE 906 may monitor for the sidelink synchronization signal using one or more relay synchronization signal beams that were jointly selected by the remote UE 906 and the relay UE 904. The remote UE 906 may use an LP sidelink radio unit to monitor for the sidelink synchronization signal.

Based at least in part on operating in a sidelink DRX cycle and/or connecting to the network node 902 through the relay UE 904, the remote UE 906 may prioritize sidelink synchronization signals from the relay UE 904 (e.g., sidelink synchronization signals). That is, the remote UE 906 may prioritize a sidelink synchronization signal from the relay UE 904 higher than other sidelink synchronization signals. As shown by reference number 955, the remote UE 906 may iteratively monitor for the sidelink synchronization signal and/or iteratively transition between the active state and the sleep state.

As shown by reference number 960, the relay UE 904 may transmit, and the remote UE 906 may receive, a sidelink synchronization signal. While the example 900 shown by FIGS. 9A and 9B includes the remote UE 906 receiving a sidelink synchronization signal, other examples may include the remote UE 906 failing to detect a sidelink synchronization. In some aspects, based at least in part on failing to detect a sidelink synchronization signal, the remote UE 906 may select updated relay synchronization signal beams and/or exit the sidelink DRX cycle as described below with regard to reference number 990.

Examples of a sidelink synchronization signal may include a sidelink synchronization signal block (S-SSB) and/or an LP S-SSB, and the LP S-SSB may have a lower power level relative to the S-SSB. The relay UE 904 may transmit the sidelink synchronization signal using the relay synchronization resource(s) that are dedicated to the sidelink synchronization signal and/or are different from the pre-configured sidelink SSB synchronization resources as described above. Alternatively, or additionally, the relay UE 904 and/or the remote UE 906 may transmit and/or receive the sidelink synchronization signal using the one or more relay synchronization signal beams jointly selected by the remote UE 906 and the relay UE 904 as described with regard to reference number 930. In some aspects, the remote UE 906 may select updated relay synchronization signal beams as described below with regard to reference number 990.

The sidelink synchronization signal may include sidelink synchronization information. For example, the sidelink synchronization information may include one or more sidelink SSB IDs that indicate that the sidelink synchronization signal is dedicated to a sidelink relay operation. Alternatively, or additionally, the sidelink SSB IDs may indicate to other UEs monitoring a sidelink to not use the sidelink synchronization signal to obtain synchronization information.

Based at least in part on receiving the sidelink synchronization signal, as shown by reference number 965, the remote UE 906 may monitor for a wake-up signal. For example, the remote UE 906 may monitor one or more air interface resources that are assigned to a wake-up signal in one or more wake-up signal periods and/or one or more wake-up signal occasions. In some aspects, the remote UE 906 may monitor for an LP wake-up signal (e.g., using an LP radio unit). As shown by reference number 955, the remote UE 906 may iteratively monitor for the wake-up signal. Based at least in part on not detecting a wake-up signal, the remote UE 906 may transition to a sleep state and/or an inactive state of the sidelink DRX cycle. In some aspects, as shown by reference number 975, the remote UE 906 may iteratively monitor for a sidelink synchronization signal and/or a wake-up signal, such as by monitoring for the sidelink synchronization signal and/or the wake-up signal at each transition to an active state of the sidelink DRX cycle. Alternatively, or additionally, the remote UE 906 may detect a wake-up signal as described below with regard to reference number 985.

As shown by reference number 980, the network node 902 may transmit, and the relay UE 904 may receive, a wake-up instruction (e.g., a paging message, a paging early indication (PEI), and/or an LP wake-up signal) that is directed to the remote UE 906. For clarity, FIG. 9B illustrates the network node 902 transmitting the wake-up instruction in a sequential manner with the remote UE 906 receiving a sidelink synchronization signal and monitoring for a wake-up signal (e.g., after the remote UE 906 receives the sidelink synchronization signal and begins monitoring for the wake-up signal). However, the network node 902 may transmit the wake-up instruction prior to the remote UE 906 receiving a sidelink synchronization signal and/or prior to the remote UE 906 monitoring for a wake-up signal. For instance, the network node 902 may transmit the wake-up instruction during an inactive state and/or sleep state of the remote UE 906, and the relay UE 904 may synchronize the transmission of wake-up signal with an active state of the remote UE 906.

Accordingly, as shown by reference number 985, the relay UE 904 may transmit, and the remote UE 906 may receive, a wake-up signal. For example, the relay UE 904 may map the wake-up instruction from the network node 902 to the remote UE 906, and transmit the wake-up signal based at least in part on determining the wake-up instruction is associated with the remote UE 906. The wake-up signal transmitted by the relay UE 904 may be a sidelink SSB and/or a sidelink LP SSB.

As one example, the relay UE 904 may transmit the wake-up signal in a wake-up signal occasion and/or a wake-up signal period of the remote UE 906. The relay UE 904 may indicate, in the wake-up signal, a wake-up signal identifier, such as the wake-up signal identifier described with regard to reference number 935 (e.g., a wake-up signal identifier that is assigned to the remote UE 906). For instance, the wake-up signal may indicate a group ID and/or a sequence ID assigned to the remote UE 906 as described above, and the remote UE 906 may decode the group ID and/or sequence ID to determine that the wake-up signal is directed to the remote UE 906.

The relay UE 904 may transmit the wake-up signal as an LP wake-up signal (e.g., a sidelink LP SSB). For instance, based at least in part on the remote UE 906 indicating support for LP wake-up signals and/or instructing the remote UE 906 to monitor for an LP wake-up signal, the relay UE 904 may transmit the LP wake-up signal.

Alternatively, or additionally, the relay UE 904 may transmit an SCI-based wake-up signal that is a wake-up signal that is transmitted in an SCI slot, such as a pre-configured SCI slot, and/or a dedicated SCI slot, for an SCI-based wake-up signal, where signals other than a wake-up signal may be disallowed in the pre-configured SCI slot and/or the dedicated SCI slot. In other aspects, the relay UE 904 may transmit the wake-up signal in sidelink slot that is formatted to include the wake-up signal followed by one or more AGC symbols. In some aspects, an AGC symbol may carry a signal (sometimes a repetition of the transmitted signal) that a receiver may use to calculate a signal power level that is used to adjust an AGC. The use of a pre-configured SCI slot, a dedicated SCI slot, and/or a sidelink slot that is formatted to include the wake-up signal followed by one or more AGC symbols may enable the remote UE 906 to train and/or calibrate an AGC at the remote UE 906 to mitigate hardware saturation and/or to mitigate receive errors. To illustrate, a sidelink resource pool (e.g., air interface resource pool) may be shared among multiple UEs, and signals in the resources within the sidelink resource pool may vary (e.g., varying signal power levels and/or varying interference levels). Based at least in part on operating in a sidelink DRX cycle, an AGC in a receiver of the remote UE 906 may need time to calibrate and/or adjust to mitigate reception errors (e.g., hardware saturation) at the remote UE 906, and the variation in signal power levels and/or interference levels may result in the remote UE 906 configuring the AGC in a manner that results in hardware saturation and/or underutilization (e.g., desaturation). The use of a pre-configured SCI slot and/or a dedicated SCI slot may mitigate variation in signal levels that may result in an AGC configuration that causes receive errors at the remote UE 906, and a sidelink slot that is formatted to include the wake-up signal followed by one or more AGC symbols may allow the remote UE 906 time to calibrate and/or adjust the AGC to mitigate an improper AGC configuration.

In some aspects, a sidelink slot that is formatted to include the wake-up signal followed by one or more AGC symbols may be formatted with one or more AGC symbols near or at a middle of the sidelink slot (e.g., instead of an edge), such as at symbol k in the sidelink slot, where k is an integer. A sidelink slot that is formatted to include the wake-up signal followed by one or more AGC symbols may not be dedicated to only wake-up signal transmissions and/or may be used for a variety of transmissions. That is, the sidelink slot that is formatted to include the wake-up signal followed by one or more AGC symbols may not be exclusive to wake-up signals and may be used for non-wake-up signal transmissions in a sidelink. A transmit sidelink UE using the sidelink slot that is formatted to include the wake-up signal followed by one or more AGC symbols for a non-wake-up signal transmission may transmit a particular signal in the symbol k and repeat transmission of the particular signal in the symbol k+1. The repetition of the particular signal enables a receive sidelink UE to perform AGC training using the particular signal in the symbol k and recover content in the particular signal using the symbol k+1. A remote UE operating with an enabled DRX mode (e.g., the remote UE 906 operating in an enabled sidelink DRX mode) may receive and/or decode a signal carried in symbol 0 to symbol k−1 of the AGC slot and may disable a receiver of the decoded information does not include a group ID and/or a sequence ID associated with the remote UE. A scheduling pattern may periodically include a sidelink slot that is formatted to include the wake-up signal followed by one or more AGC symbols, such as every 10 milliseconds (msec), every 20 msec, and/or every 50 msec.

Based at least in part on receiving the sidelink synchronization signal as described with regard to reference number 960 and receiving the wake-up signal as described with regard to reference number 985, the remote UE 906 may exit the sidelink DRX cycle as shown by reference number 990. For instance, based at least in part on being in a sleep state of a sidelink DRX cycle, the remote UE 906 may initially only power an LP radio unit to detect an LP wake-up signal and/or a sidelink synchronization signal. Based at least in part on detecting the LP wake-up signal, the remote UE 906 may exit the sidelink DRX sleep state, resulting in the remote UE 906 supplying more power to more circuits (e.g., a non-LP radio unit and/or a non-LP receiver) to enable successfully transmission and/or reception of communications.

However, in other aspects, the remote UE 906 may exit the sidelink DRX cycle based at least in part on other factors. As one example, the remote UE 906 may monitor for the sidelink synchronization signal using one or more relay synchronization signal beams and/or one or more air interface resources associated with a sidelink synchronization signal as described with regard to reference number 950. In some aspects, the remote UE 906 may validate a presence of a sidelink synchronization signal by calculating a signal quality metric using a signal that is received using a relay synchronization signal beam and/or a sidelink synchronization signal air interface resource. The remote UE 906 may determine that the signal quality measurement metric fails to satisfy a detection threshold, which the remote UE 906 may interpret as a failure. Failure to detect a sidelink synchronization signal may include not detecting a sidelink synchronization signal and/or observing signal degradation in the sidelink synchronization signal. Based at least in part on failing to detect a sidelink synchronization signal, the remote UE 906 may exit the sidelink DRX cycle.

Alternatively, or additionally, the remote UE 906 may select updated relay synchronization signal beams. To illustrate, the remote UE 906 may fail to detect the sidelink synchronization signal using the relay synchronization signal beam(s) jointly selected by the remote UE 906 and the relay UE 904. In such a scenario, the remote UE 906 may select one or more updated relay synchronization signal beams. For instance, the remote UE 906 may use one or more beam training sidelink resources, one or more pre-configured reference signals, and/or one or more pre-configured beams (e.g., indicated by the relay UE 904) to generate one or more signal quality measurement metrics. The remote UE 906 may select one or more updated relay synchronization signal beams based at least in part on the signal quality measurement metrics, such as by selecting the beam associated with the highest signal quality measurement metric in the group of signal quality measurement metrics. A beam training sidelink resource may be included in a sidelink resource pool, a sidelink synchronization resource pool, and/or may be dedicated sidelink resources (e.g., dedicated for beam training). The use of pre-configured reference signals and/or pre-determined beams may enable the remote UE 906 to mitigate losing synchronization with the relay UE 904 while operating in a sidelink DRX cycle. However, in some aspects, the remote UE 906 may fail to detect the sidelink synchronization signal using the updated relay synchronization signal beams. In such a scenario, the remote UE 906 may exit the sidelink DRX cycle and attempt to discover and/or re-discover a relay UE.

In some aspects, the remote UE 906 may exit the sidelink DRX cycle based at least in part on detecting one or more trigger events. As one example, the remote UE 906 may change locations and detect access to a service coverage area provided by the network node 902, and may exit the sidelink DRX cycle based at least in part on detecting the access to the service coverage area. That is, the remote UE 906 may exit the sidelink DRX cycle based at least in part on detecting a trigger event and without receiving a sidelink synchronization signal and/or without receiving a wake-up signal.

Prioritizing a synchronization signal from a relay UE may enable a remote UE to mitigate a mismatch in sidelink synchronization with the relay UE. Mitigating a mismatch in sidelink synchronization between a remote UE and a relay UE may mitigate a dropped sidelink connection, may decrease data recovery errors in the sidelink, may increase data throughput in the sidelink, and/or may decrease data transfer latency in the sidelink.

As indicated above, FIG. 9 is provided as an example. Other examples may differ from what is described with regard to FIG. 9.

FIG. 10 is a diagram illustrating an example process 1000 performed, for example, at a UE or an apparatus of a UE, in accordance with the present disclosure. Example process 1000 is an example where the apparatus or the UE (e.g., UE 120) performs operations associated with sidelink synchronization signaling.

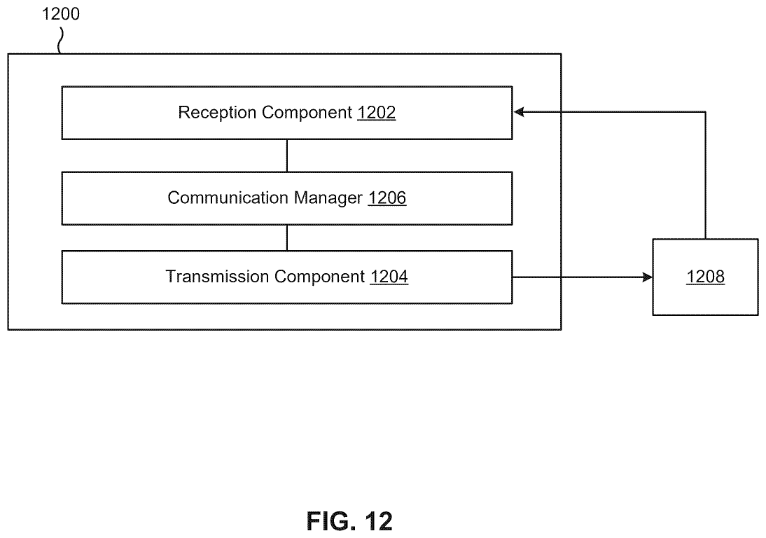

As shown in FIG. 10, in some aspects, process 1000 may include establishing a sidelink with a relay UE (block 1010). For example, the UE (e.g., using communication manager 1206, depicted in FIG. 12) may establish a sidelink with a relay UE, as described above.

As further shown in FIG. 10, in some aspects, process 1000 may include transmitting a DRX indication that indicates that the remote UE is entering a sidelink DRX cycle that includes one or more active states and one or more sleep states, the one or more active states synchronized with one or more wake-up signal periods (block 1020). For example, the UE (e.g., using transmission component 1204 and/or communication manager 1206, depicted in FIG. 12) may transmit a DRX indication that indicates that the remote UE is entering a sidelink DRX cycle that includes one or more active states and one or more sleep states, the one or more active states synchronized with one or more wake-up signal periods, as described above.

As further shown in FIG. 10, in some aspects, process 1000 may include receiving a sidelink synchronization signal based at least in part on prioritizing synchronization signals from the relay UE (block 1030). For example, the UE (e.g., using reception component 1202 and/or communication manager 1206, depicted in FIG. 12) may receive a sidelink synchronization signal based at least in part on prioritizing synchronization signals from the relay UE, as described above.

As further shown in FIG. 10, in some aspects, process 1000 may include monitoring, based at least in part on receiving the sidelink synchronization signal, for a wake-up signal in the one or more wake-up signal periods (block 1040). For example, the UE (e.g., using communication manager 1206, depicted in FIG. 12) may monitor, based at least in part on receiving the sidelink synchronization signal, for a wake-up signal in the one or more wake-up signal periods, as described above.

Process 1000 may include additional aspects, such as any single aspect or any combination of aspects described below and/or in connection with one or more other processes described elsewhere herein.

In a first aspect, the sidelink synchronization signal includes at least one of an S-SSB, or an LP S-SSB.

In a second aspect, wherein receiving the sidelink synchronization signal from the relay UE includes receiving the sidelink synchronization signal in one or more relay synchronization resources that are dedicated to the sidelink synchronization signal, the one or more relay synchronization resources being different from one or more pre-configured sidelink synchronization signal block synchronization resources.

In a third aspect, process 1000 includes transmitting, prior to entering the sidelink DRX cycle, a capability indication that indicates that the remote UE supports reception of an LP SSB, and receiving, from the relay UE, an instruction to monitor for an LP SSB as the sidelink synchronization signal.

In a fourth aspect, the instruction indicates to monitor for the LP SSB using an LP sidelink radio unit.

In a fifth aspect, the sidelink synchronization signal includes sidelink synchronization information.

In a sixth aspect, the sidelink synchronization information includes one or more sidelink synchronization signal block identifiers that indicate that the sidelink synchronization signal is dedicated to a sidelink relay operation.

In a seventh aspect, the remote UE and the relay UE are configured to communicate via the sidelink using one or more beams, and monitoring for the sidelink synchronization signal includes monitoring for the sidelink synchronization signal using relay synchronization signal beams.

In an eighth aspect, process 1000 includes communicating with the relay UE prior to entering the sidelink DRX cycle to jointly select the one or more relay synchronization signal beams for transmission or reception of the sidelink synchronization signal.

In a ninth aspect, process 1000 includes failing to detect the sidelink synchronization signal using the one or more relay synchronization signal beams, and selecting, based at least in part on failing to detect the sidelink synchronization signal, one or more updated relay synchronization signal beams.

In a tenth aspect, selecting the one or more updated synchronization signal beams includes selecting the one or more updated synchronization signal beams using one or more beam training sidelink resources.

In an eleventh aspect, process 1000 includes failing to detect the sidelink synchronization signal using the one or more relay synchronization signal beams, failing to detect the sidelink synchronization signal using one or more updated relay synchronization signal beams, and exiting the sidelink DRX cycle based at least in part on failing to detect the sidelink synchronization signal using the one or more relay synchronization signal beams and the one or more updated relay synchronization signal beams.

In a twelfth aspect, process 1000 includes failing to detect the sidelink synchronization signal from the relay UE, and exiting the sidelink DRX cycle based at least in part on failing to detect the sidelink synchronization signal from the relay UE.

In a thirteenth aspect, process 1000 includes detecting access to a service coverage area provided by a network node, and exiting the sidelink DRX cycle based at least in part on detecting the access to the service coverage area.

In a fourteenth aspect, process 1000 includes receiving a wake-up signal from the relay UE, and exiting the sidelink DRX cycle based at least in part on receiving the wake-up signal from the relay UE.

In a fifteenth aspect, process 1000 includes receiving, prior to entering the sidelink DRX cycle, a wake-up signal identifier that is assigned to the remote UE, and the wake-up signal indicates the wake-up signal identifier.

In a sixteenth aspect, the wake-up signal identifier includes at least one of a group identifier, or a sequence identifier.

In a seventeenth aspect, the wake-up signal includes a low power wake-up signal, or an SCI-based wake-up signal.

In an eighteenth aspect, the wake-up signal includes the SCI-based wake-up signal, and receiving the wake-up signal includes receiving the SCI-based wake-up signal in an SCI slot that is dedicated to the SCI-based wake-up signal.

In a nineteenth aspect, process 1000 includes receiving the wake-up signal in a sidelink slot that is formatted to include one or more automatic gain control symbols.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram illustrating an example process 1100 performed, for example, at a UE or an apparatus of a UE, in accordance with the present disclosure. Example process 1100 is an example where the apparatus or the UE (e.g., UE 120) performs operations associated with sidelink synchronization signaling.

As shown in FIG. 11, in some aspects, process 1100 may include establishing a sidelink with a remote UE (block 1110). For example, the UE (e.g., using communication manager 1206, depicted in FIG. 12) may establish a sidelink with a remote UE, as described above.

As further shown in FIG. 11, in some aspects, process 1100 may include receiving a DRX indication that indicates that the remote UE is entering a sidelink DRX cycle that includes one or more active states and one or more sleep states, the one or more active states synchronized with one or more wake-up signal periods (block 1120). For example, the UE (e.g., using reception component 1202 and/or communication manager 1206, depicted in FIG. 12) may receive a DRX indication that indicates that the remote UE is entering a sidelink DRX cycle that includes one or more active states and one or more sleep states, the one or more active states synchronized with one or more wake-up signal periods, as described above.

As further shown in FIG. 11, in some aspects, process 1100 may include operating, based at least in part on receiving the DRX indication, as a relay synchronization source for the remote UE (block 1130). For example, the UE (e.g., using communication manager 1206, depicted in FIG. 12) may operate, based at least in part on receiving the DRX indication, as a relay synchronization source for the remote UE, as described above.

As further shown in FIG. 11, in some aspects, process 1100 may include transmitting, based at least in part on operating as the relay synchronization source, a sidelink synchronization signal that is directed to the remote UE (block 1140). For example, the UE (e.g., using transmission component 1204 and/or communication manager 1206, depicted in FIG. 12) may transmit, based at least in part on operating as the relay synchronization source, a sidelink synchronization signal that is directed to the remote UE, as described above.

Process 1100 may include additional aspects, such as any single aspect or any combination of aspects described below and/or in connection with one or more other processes described elsewhere herein.

In a first aspect, the sidelink synchronization signal includes at least one of an S-SSB, or an LP S-SSB.

In a second aspect, process 1100 includes transmitting the sidelink synchronization signal in one or more relay synchronization resources that are dedicated to the sidelink synchronization signal, the one or more relay synchronization resources being different from one or more pre-configured sidelink synchronization signal block synchronization resources.

In a third aspect, process 1100 includes receiving a capability indication that indicates that the remote UE supports reception of an LP SSB, and transmitting, based at least in part on receiving the capability indication, an instruction to monitor for an LP SSB as the sidelink synchronization signal.

In a fourth aspect, the instruction indicates to monitor for the LP SSB using an LP sidelink radio unit.

In a fifth aspect, the sidelink synchronization signal includes sidelink synchronization information.

In a sixth aspect, the sidelink synchronization information includes one or more sidelink synchronization signal block identifiers that indicate that the sidelink synchronization signal is dedicated to a sidelink relay operation.

In a seventh aspect, the remote UE and the relay UE are configured to communicate via the sidelink using one or more beams, and transmitting the sidelink synchronization signal includes transmitting the sidelink synchronization signal using one or more relay synchronization signal beams.

In an eighth aspect, process 1100 includes communicating with the remote UE to jointly select a relay synchronization signal beam for transmission or reception of the sidelink synchronization signal.

In a ninth aspect, process 1100 includes transmitting a wake-up signal identifier that is assigned to the remote UE, and transmitting, in a wake-up signal occasion of the remote UE, a wake-up signal that indicates the wake-up signal identifier.

In a tenth aspect, the wake-up signal identifier includes at least one of a group identifier, or a sequence identifier.

In an eleventh aspect, the wake-up signal includes a low power wake-up signal, or an SCI-based wake-up signal.

In a twelfth aspect, the wake-up signal includes the SCI-based wake-up signal, and transmitting the wake-up signal includes transmitting the SCI-based wake-up signal in an SCI slot that is dedicated to the SCI-based wake-up signal.

In a thirteenth aspect, transmitting the wake-up signal includes transmitting the wake-up signal in a sidelink slot that is formatted to include one or more automatic gain control symbols.

In a fourteenth aspect, process 1100 includes deriving, based at least in part on operating as the relay synchronization source, synchronization reference timing information that is used for the sidelink synchronization signal from at least one of a network node serving the relay UE, a GNSS, or a current synchronization reference of the relay UE.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram of an example apparatus 1200 for wireless communication, in accordance with the present disclosure. In some aspects, the apparatus 1200 may be a remote UE (e.g., a UE 120), or a remote UE may include the apparatus 1200. Alternatively, or additionally, the apparatus 1200 may be a relay UE (e.g., a UE 120), or a relay UE may include the apparatus 1200. In some aspects, the apparatus 1200 includes a reception component 1202, a transmission component 1204, and/or a communication manager 1206, which may be in communication with one another (for example, via one or more buses and/or one or more other components). In some aspects, the communication manager 1206 is the communication manager 140 described in connection with FIG. 1. As shown, the apparatus 1200 may communicate with another apparatus 1208, such as a UE or a network node (such as a CU, a DU, an RU, or a base station), using the reception component 1202 and the transmission component 1204.

In some aspects, the apparatus 1200 may be configured to perform one or more operations described herein in connection with FIGS. 8-9. Additionally, or alternatively, the apparatus 1200 may be configured to perform one or more processes described herein, such as process 1000 of FIG. 10, process 1100 of FIG. 11, or a combination thereof. In some aspects, the apparatus 1200 and/or one or more components shown in FIG. 12 may include one or more components of the remote user equipment described in connection with FIG. 1 and FIG. 2. Additionally, or alternatively, one or more components shown in FIG. 12 may be implemented within one or more components described in connection with FIG. 1 and FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1202 may receive communications, such as reference signals, control information, data communications, or a combination thereof, from the apparatus 1208. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1200. In some aspects, the reception component 1202 may include one or more antennas, one or more modems, one or more demodulators, one or more MIMO detectors, one or more receive processors, one or more controllers/processors, one or more memories, or a combination thereof, of the remote user equipment described in connection with FIG. 1 and FIG. 2.

The transmission component 1204 may transmit communications, such as reference signals, control information, data communications, or a combination thereof, to the apparatus 1208. In some aspects, one or more other components of the apparatus 1200 may generate communications and may provide the generated communications to the transmission component 1204 for transmission to the apparatus 1208. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1208. In some aspects, the transmission component 1204 may include one or more antennas, one or more modems, one or more modulators, one or more transmit MIMO processors, one or more transmit processors, one or more controllers/processors, one or more memories, or a combination thereof, of the remote user equipment described in connection with FIG. 1 and FIG. 2. In some aspects, the transmission component 1204 may be co-located with the reception component 1202 in one or more transceivers.

The communication manager 1206 may support operations of the reception component 1202 and/or the transmission component 1204. For example, the communication manager 1206 may receive information associated with configuring reception of communications by the reception component 1202 and/or transmission of communications by the transmission component 1204. Additionally, or alternatively, the communication manager 1206 may generate and/or provide control information to the reception component 1202 and/or the transmission component 1204 to control reception and/or transmission of communications.

Based at least in part on the apparatus 1200 being a remote UE, or a remote UE including the apparatus 1200, the communication manager 1206 may establish a sidelink with a relay UE. The transmission component 1204 may transmit a DRX indication that indicates that the remote UE is entering a sidelink DRX cycle that includes one or more active states and one or more sleep states, the one or more active states synchronized with one or more wake-up signal periods. The reception component 1202 may receive a sidelink synchronization signal based at least in part on prioritizing synchronization signals from the relay UE. The communication manager 1206 may monitor for a wake-up signal, for a in one of the one or more wake-up signal periods.

The reception component 1202 may receive the sidelink synchronization signal from the relay UE in one or more relay synchronization resources that are dedicated to the sidelink synchronization signal, the one or more relay synchronization resources being different from one or more pre-configured sidelink synchronization signal block synchronization resources. In some aspects, the transmission component 1204 may transmit, prior to entering the sidelink DRX cycle, a capability indication that indicates that the remote UE supports reception of an LP SSB. Based at least in part on transmitting the capability information, the reception component 1202 may receive, from the relay UE, an instruction to monitor for an LP SSB as the sidelink synchronization signal.

The communication manager 1206 may communicate with the relay UE prior to entering the sidelink DRX cycle to jointly select one or more relay synchronization signal beams for transmission or reception of the sidelink synchronization signal. In some aspects, the communication manager 1206 may fail to detect the sidelink synchronization signal using the one or more relay synchronization signal beams. In some aspects, the communication manager 1206 may select, based at least in part on failing to detect the sidelink synchronization signal, one or more updated synchronization signal beams. The communication manager 1206 may fail to detect the sidelink synchronization signal using one or more updated relay synchronization signal beams. Based at least in part on failing to detect the sidelink synchronization signal using the one or more relay synchronization signal beams and the one or more updated relay synchronization signal beams, the communication manager 1206 may exit the sidelink DRX cycle.

In some aspects, the communication manager 1206 may fail to detect the sidelink synchronization signal from the relay UE, and the communication manager 1206 may exit the sidelink DRX cycle based at least in part on failing to detect the sidelink synchronization signal from the relay UE. In other aspects, the communication manager 1206 may detect access to a service coverage area provided by a network node, and the communication manager 1206 may exit the sidelink DRX cycle based at least in part on detecting the access to the service coverage area.

The reception component 1202 may receive a wake-up signal from the relay UE, and the communication manager 1206 may exit the sidelink DRX cycle based at least in part on receiving the wake-up signal from the relay UE. In some aspects, the reception component 1202 may receive, prior to entering the sidelink DRX cycle, a wake-up signal identifier that is assigned to the remote UE wherein the wake-up signal indicates the wake-up signal identifier. Alternatively, or additionally, the reception component 1202 may receive the wake-up signal in a sidelink slot that is formatted to include one or more automatic gain control symbols.

Based at least in part on the apparatus 1200 being a relay UE, or a relay UE including the apparatus 1200, the communication manager 1206 may establish a sidelink with a remote UE. The reception component 1202 may receive a DRX indication that indicates that the remote UE is entering a sidelink DRX cycle that includes one or more active states and one or more sleep states, the one or more active states synchronized with one or more wake-up signal periods. The communication manager 1206 may operate, based at least in part on receiving the DRX indication, as a relay synchronization source for the remote UE. The transmission component 1204 may transmit, based at least in part on operating as the relay synchronization source, a sidelink synchronization signal that is directed to the remote UE.

The transmission component 1204 may transmit the sidelink synchronization signal in one or more relay synchronization resources that are dedicated to the sidelink synchronization signal, the one or more relay synchronization resources being different from one or more pre-configured sidelink synchronization signal block synchronization resources.

The reception component 1202 may receive a capability indication that indicates that the remote UE supports reception of an LP SSB. In some aspects, the transmission component 1204 may transmit, based at least in part on receiving the capability indication, an instruction to monitor for an LP SSB as the sidelink synchronization signal. The communication manager 1206 may communicate with the remote UE to jointly select one or more relay synchronization signal beams for transmission or reception of the sidelink synchronization signal.

The transmission component 1204 may transmit a wake-up signal identifier that is assigned to the remote UE. In some aspects, the transmission component 1204 may transmit, in a wake-up signal occasion of the remote UE, a wake-up signal that indicates the wake-up signal identifier. The communication manager 1206 may derive, based at least in part on operating as the relay synchronization source, synchronization reference timing information that is used for the sidelink synchronization signal from at least one of a network node serving the relay UE, a GNSS, or a current synchronization reference of the relay UE.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

The following provides an overview of some Aspects of the present disclosure:
Aspect 1: A method of wireless communication performed by a remote user equipment (UE), comprising: establishing a sidelink with a relay UE; transmitting a discontinuous reception (DRX) indication that indicates that the remote UE is entering a sidelink DRX cycle that includes one or more active states and one or more sleep states, the one or more active states synchronized with one or more wake-up signal periods; receiving a sidelink synchronization signal based at least in part on prioritizing synchronization signals from the relay UE; and monitoring, based at least in part on receiving the sidelink synchronization signal, for a wake-up signal in the one or more wake-up signal periods.
Aspect 2: The method of Aspect 1, wherein the sidelink synchronization signal comprises at least one of: a sidelink synchronization signal block (S-SSB), or a low power (LP) S-SSB.
Aspect 3: The method of any of Aspects 1-2, further comprising: receiving the sidelink synchronization signal from the relay UE in one or more relay synchronization resources that are dedicated to the sidelink synchronization signal, the one or more relay synchronization resources being different from one or more pre-configured sidelink synchronization signal block synchronization resources.
Aspect 4: The method of any of Aspects 1-3, further comprising: transmitting, prior to entering the sidelink DRX cycle, a capability indication that indicates that the remote UE supports reception of a low power (LP) synchronization signal block (SSB); and receiving, from the relay UE, an instruction to monitor for an LP SSB as the sidelink synchronization signal.
Aspect 5: The method of Aspect 4, wherein the instruction indicates to monitor for the LP SSB using an LP sidelink radio unit.
Aspect 6: The method of any of Aspects 1-5, wherein the sidelink synchronization signal includes sidelink synchronization information.
Aspect 7: The method of Aspect 6, wherein the sidelink synchronization information comprises one or more sidelink synchronization signal block identifiers that indicate that the sidelink synchronization signal is dedicated to a sidelink relay operation.
Aspect 8: The method of any of Aspects 1-7, wherein the remote UE and the relay UE are configured to communicate via the sidelink using one or more beams, and wherein the method further comprises: monitoring for the sidelink synchronization signal using one or more relay synchronization signal beams.
Aspect 9: The method of Aspect 8, further comprising: communicating with the relay UE prior to entering the sidelink DRX cycle to jointly select the one or more relay synchronization signal beams for transmission or reception of the sidelink synchronization signal.
Aspect 10: The method of Aspect 9, further comprising: failing to detect the sidelink synchronization signal using the one or more relay synchronization signal beams; and selecting, based at least in part on failing to detect the sidelink synchronization signal, one or more updated relay synchronization signal beams.
Aspect 11: The method of Aspect 10, wherein selecting the one or more updated synchronization signal beams comprises: selecting the one or more updated synchronization signal beams using one or more beam training sidelink resources.
Aspect 12: The method of Aspect 9, further comprising: failing to detect the sidelink synchronization signal using the one or more relay synchronization signal beams; failing to detect the sidelink synchronization signal using one or more updated relay synchronization signal beams; and exiting the sidelink DRX cycle based at least in part on failing to detect the sidelink synchronization signal using the one or more relay synchronization signal beams and the one or more updated relay synchronization signal beams.
Aspect 13: The method of any of Aspects 1-12, further comprising: failing to detect the sidelink synchronization signal from the relay UE; and exiting the sidelink DRX cycle based at least in part on failing to detect the sidelink synchronization signal from the relay UE.
Aspect 14: The method of any of Aspects 1-13, further comprising: detecting access to a service coverage area provided by a network node; and exiting the sidelink DRX cycle based at least in part on detecting the access to the service coverage area.
Aspect 15: The method of any of Aspects 1-14, further comprising: receiving a wake-up signal from the relay UE; and exiting the sidelink DRX cycle based at least in part on receiving the wake-up signal from the relay UE.
Aspect 16: The method of any of Aspects 1-15, further comprising: receiving, prior to entering the sidelink DRX cycle, a wake-up signal identifier that is assigned to the remote UE, wherein the wake-up signal indicates the wake-up signal identifier.
Aspect 17: The method of Aspect 16, wherein the wake-up signal identifier comprises at least one of: a group identifier, or a sequence identifier.
Aspect 18: The method of Aspect 15, wherein the wake-up signal comprises: a low power wake-up signal, or a sidelink control information (SCI)-based wake-up signal.
Aspect 19: The method of Aspect 18, wherein the wake-up signal comprises the SCI-based wake-up signal, and wherein receiving the wake-up signal comprises: receiving the SCI-based wake-up signal in an SCI slot that is dedicated to the SCI-based wake-up signal.
Aspect 20: The method of Aspect 15, receiving the wake-up signal from the relay UE comprises: receiving the wake-up signal in a sidelink slot that is formatted to include one or more automatic gain control symbols.
Aspect 21: A method of wireless communication performed by a relay user equipment (UE), comprising: establishing a sidelink with a remote UE; receiving a discontinuous reception (DRX) indication that indicates that the remote UE is entering a sidelink DRX cycle that includes one or more active states and one or more sleep states, the one or more active states synchronized with one or more wake-up signal periods; operating, based at least in part on receiving the DRX indication, as a relay synchronization source for the remote UE; and transmitting, based at least in part on operating as the relay synchronization source, a sidelink synchronization signal that is directed to the remote UE.
Aspect 22: The method of Aspect 21, wherein the sidelink synchronization signal comprises at least one of: a sidelink synchronization signal block (S-SSB), or a low power (LP) S-SSB.
Aspect 23: The method of any of Aspects 21-22 further comprising: transmitting the sidelink synchronization signal in one or more relay synchronization resources that are dedicated to the sidelink synchronization signal, the one or more relay synchronization resources being different from one or more pre-configured sidelink synchronization signal block synchronization resources.
Aspect 24: The method of any of Aspects 21-23, further comprising: receiving a capability indication that indicates that the remote UE supports reception of a low power (LP) synchronization signal block (SSB); and transmitting, based at least in part on receiving the capability indication, an instruction to monitor for an LP SSB as the sidelink synchronization signal.
Aspect 25: The method of Aspect 24, wherein the instruction indicates to monitor for the LP SSB using an LP sidelink radio unit.
Aspect 26: The method of any of Aspects 21-25, wherein the sidelink synchronization signal includes sidelink synchronization information.
Aspect 27: The method of Aspect 26, wherein the sidelink synchronization information comprises one or more sidelink synchronization signal block identifiers that indicate that the sidelink synchronization signal is dedicated to a sidelink relay operation.
Aspect 28: The method of any of Aspects 21-27, wherein the remote UE and the relay UE are configured to communicate via the sidelink using one or more beams, and wherein transmitting the sidelink synchronization signal comprises: transmitting the sidelink synchronization signal using one or more relay synchronization signal beams.
Aspect 29: The method of Aspect 28, further comprising: communicating with the remote UE to jointly select the one or more relay synchronization signal beams for transmission or reception of the sidelink synchronization signal.
Aspect 30: The method of any of Aspects 21-29, further comprising: transmitting a wake-up signal identifier that is assigned to the remote UE; and transmitting, in a wake-up signal occasion of the remote UE, a wake-up signal that indicates the wake-up signal identifier.
Aspect 31: The method of Aspect 30, wherein the wake-up signal identifier comprises at least one of: a group identifier, or a sequence identifier.
Aspect 32: The method of Aspect 30, wherein the wake-up signal comprises: a low power wake-up signal, or a sidelink control information (SCI)-based wake-up signal.
Aspect 33: The method of Aspect 32, wherein the wake-up signal comprises the SCI-based wake-up signal, and wherein transmitting the wake-up signal comprises: transmitting the SCI-based wake-up signal in an SCI slot that is dedicated to the SCI-based wake-up signal.
Aspect 34: The method of Aspect 30, wherein transmitting the wake-up signal comprises: transmitting the wake-up signal in a sidelink slot that is formatted to include one or more automatic gain control symbols.
Aspect 35: The method of any of Aspects 21-34, further comprising: deriving, based at least in part on operating as the relay synchronization source, synchronization reference timing information that is used for the sidelink synchronization signal from at least one of: a network node serving the relay UE, a global navigation satellite system (GNSS), or a current synchronization reference of the relay UE.
Aspect 36: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-35.
Aspect 37: An apparatus for wireless communication at a device, the apparatus comprising one or more memories and one or more processors coupled to the one or more memories, the one or more processors configured to cause the device to perform the method of one or more of Aspects 1-35.
Aspect 38: An apparatus for wireless communication, the apparatus comprising at least one means for performing the method of one or more of Aspects 1-35.
Aspect 39: A non-transitory computer-readable medium storing code for wireless communication, the code comprising instructions executable by one or more processors to perform the method of one or more of Aspects 1-35.
Aspect 40: A non-transitory computer-readable medium storing a set of instructions for wireless communication, the set of instructions comprising one or more instructions that, when executed by one or more processors of a device, cause the device to perform the method of one or more of Aspects 1-35.
Aspect 41: A device for wireless communication, the device comprising a processing system that includes one or more processors and one or more memories coupled with the one or more processors, the processing system configured to cause the device to perform the method of one or more of Aspects 1-35.
Aspect 42: An apparatus for wireless communication at a device, the apparatus comprising one or more memories and one or more processors coupled to the one or more memories, the one or more processors individually or collectively configured to cause the device to perform the method of one or more of Aspects 1-35.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware or a combination of hardware and at least one of software or firmware. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. It will be apparent that systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a +b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A may also have B). Further, the phrase “based on” is intended to mean “based on or otherwise in association with” unless explicitly stated otherwise. Also, as used herein, the term “or” is intended to be inclusive when used in a series and may be used interchangeably with “and/or,” unless explicitly stated otherwise (for example, if used in combination with “either” or “only one of”). It should be understood that “one or more” is equivalent to “at least one.”

Even though particular combinations of features are recited in the claims or disclosed in the specification, these combinations are not intended to limit the disclosure of various aspects. Many of these features may be combined in ways not specifically recited in the claims or disclosed in the specification. The disclosure of various aspects includes each dependent claim in combination with every other claim in the claim set.

What is claimed is:

1. An apparatus for wireless communication at a remote user equipment (UE), comprising:
one or more memories; and
one or more processors, coupled to the one or more memories, configured to cause the UE to:
establish a sidelink with a relay UE;
transmit a discontinuous reception (DRX) indication that indicates that the remote UE is entering a sidelink DRX cycle that includes one or more active states and one or more sleep states, the one or more active states synchronized with one or more wake-up signal periods;
receive a sidelink synchronization signal based at least in part on prioritizing synchronization signals from the relay UE; and
monitor, based at least in part on receiving the sidelink synchronization signal, for a wake-up signal in the one or more wake-up signal periods.

2. The apparatus of claim 1, wherein the one or more processors are further configured to cause the UE to:
receive the sidelink synchronization signal from the relay UE in one or more relay synchronization resources that are dedicated to the sidelink synchronization signal, the one or more relay synchronization resources being different from one or more pre-configured sidelink synchronization signal block synchronization resources.

3. The apparatus of claim 1, wherein the one or more processors are further configured to cause the UE to:
transmit, prior to entering the sidelink DRX cycle, a capability indication that indicates that the remote UE supports reception of a low power (LP) synchronization signal block (SSB); and
receive, from the relay UE, an instruction to monitor for an LP SSB as the sidelink synchronization signal.

4. The apparatus of claim 1, wherein the sidelink synchronization signal includes sidelink synchronization information.

5. The apparatus of claim 1, wherein the one or more processors are further configured to cause the UE to communicate via the sidelink using one or more beams, and
wherein the one or more processors are configured to cause the UE to:
monitor for the sidelink synchronization signal using one or more relay synchronization signal beams.

6. The apparatus of claim 5, wherein the one or more processors are further configured to cause the UE to:
communicate with the relay UE prior to entering the sidelink DRX cycle to jointly select the one or more relay synchronization signal beams for transmission or reception of the sidelink synchronization signal.

7. The apparatus of claim 6, wherein the one or more processors are further configured to cause the UE to:
fail to detect the sidelink synchronization signal using the one or more relay synchronization signal beams; and
select, based at least in part on failing to detect the sidelink synchronization signal, one or more updated relay synchronization signal beams.

8. The apparatus of claim 1, wherein the one or more processors are further configured to cause the UE to:
receive, prior to entering the sidelink DRX cycle, a wake-up signal identifier that is assigned to the remote UE;
receive the wake-up signal from the relay UE, wherein the wake-up signal indicates the wake-up signal identifier; and
exit the sidelink DRX cycle based at least in part on receiving the wake-up signal from the relay UE.

9. The apparatus of claim 8, wherein the wake-up signal comprises:
a low power wake-up signal, or
a sidelink control information (SCI)-based wake-up signal.

10. The apparatus of claim 9, wherein the wake-up signal comprises the SCI-based wake-up signal, and
wherein the one or more processors, to cause the UE to receive the wake-up signal, are configured to cause the UE to:
receive the SCI-based wake-up signal in an SCI slot that is dedicated to the SCI-based wake-up signal.

11. The apparatus of claim 8, wherein the one or more processors, to cause the UE to receive the wake-up signal, are configured to cause the UE to:
receive the wake-up signal in a sidelink slot that is formatted to include one or more automatic gain control symbols.

12. A method of wireless communication performed by a remote user equipment (UE), comprising:
establishing a sidelink with a relay UE;
transmitting a discontinuous reception (DRX) indication that indicates that the remote UE is entering a sidelink DRX cycle that includes one or more active states and one or more sleep states, the one or more active states synchronized with one or more wake-up signal periods;
receiving a sidelink synchronization signal based at least in part on prioritizing synchronization signals from the relay UE ; and
monitoring, based at least in part on receiving the sidelink synchronization signal, for a wake-up signal in one of the one or more wake-up signal periods. sidelink synchronization signal.

13. The method of claim 12, further comprising:
receiving the sidelink synchronization signal from the relay UE in one or more relay synchronization resources that are dedicated to the sidelink synchronization signal, the one or more relay synchronization resources being different from one or more pre-configured sidelink synchronization signal block synchronization resources.

14. The method of claim 12, wherein the sidelink synchronization signal includes sidelink synchronization information.

15. The method of claim 14, wherein the sidelink synchronization information comprises one or more sidelink synchronization signal block identifiers that indicate that the sidelink synchronization signal is dedicated to a sidelink relay operation.

16. The method of claim 12, wherein the remote UE and the relay UE are configured to communicate via the sidelink using one or more beams, and wherein the method further comprises:
monitoring for the sidelink synchronization signal using one or more relay synchronization signal beams.

17. The method of claim 16, further comprising:
communicating with the relay UE prior to entering the sidelink DRX cycle to jointly select the one or more relay synchronization signal beams for transmission or reception of the sidelink synchronization signal.

18. The method of claim 12, further comprising:
receiving the wake-up signal from the relay UE; and
exiting the sidelink DRX cycle based at least in part on receiving the wake-up signal from the relay UE.

19. A non-transitory computer-readable medium storing a set of instructions for wireless communication, the set of instructions comprising:
one or more instructions that, when executed by one or more processors of a remote user equipment (UE), cause the UE to:
establish a sidelink with a relay UE;
transmit a discontinuous reception (DRX) indication that indicates that the remote UE is entering a sidelink DRX cycle that includes one or more active states and one or more sleep states, the one or more active states synchronized with one or more wake-up signal periods;
receive a sidelink synchronization signal based at least in part on prioritizing synchronization signals from the relay UE; and
monitor, based at least in part on receiving the sidelink synchronization signal, for a wake-up signal in the one or more wake-up signal periods.

20. The non-transitory computer-readable medium of claim 19, wherein the one or more instructions further cause the UE to:
receive the sidelink synchronization signal from the relay UE in one or more relay synchronization resources that are dedicated to the sidelink synchronization signal, the one or more relay synchronization resources being different from one or more pre-configured sidelink synchronization signal block synchronization resources.
